(19) United States
(12) Patent Application Publication
(10) Pub. No.: US 2018/0018694 A1
(43) Pub. Date: Jan. 18, 2018

(54) REVOKING ELECTRONIC MESSAGES IN AN ELECTRONIC MESSAGE CAMPAIGN

(71) Applicant: Facebook, Inc., Menlo Park, CA (US)

(72) Inventors: Lior Berry, JR., Sunnyvale, CA (US); Himanshu Baweja, Sunnyvale, CA (US); Edward Young Zhang, San Francisco, CA (US); Pradeep Venkatachalam, Mountain View, CA (US); Dheeraj Kumar Singh, San Jose, CA (US); Hao Lin, Fremont, CA (US); Srinivas Prasad Govindan, Sunnyvale, CA (US); Jason Curtis Jenks, Lynnwood, WA (US)

(21) Appl. No.: 15/298,773

(22) Filed: Oct. 20, 2016

Related U.S. Application Data
(60) Provisional application No. 62/362,584, filed on Jul. 14, 2016.

(51) Int. Cl. G06Q 30/02; H04L 29/08; H04L 12/58

(52) U.S. Cl. CPC G06Q 30/0246; H04L 51/22; H04L 67/26

(57) ABSTRACT

One or more embodiments of the disclosure provide a promotional messaging system for efficiently providing promotional messages to customers via an electronic messaging system. For example, in one or more embodiments, the promotional messaging system identifies users of the electronic messaging system that have previously communicated with a merchant as part of a customized audience. Additionally, in some embodiments, the promotional messaging system analyzes activity patterns of the users to provide improved delivery of promotional messages in a non-intrusive, private, and timely manner. Overall, the promotional messaging system described herein improves communications via an electronic messaging system between users and a merchant.

### CROSS REFERENCE TO RELATED APPLICATIONS

This application claims priority to and the benefit of U.S. Provisional Application No. 62/362,584, filed Jul. 14, 2016, the entire contents of which are hereby incorporated by reference.

### BACKGROUND

Advances in modern communication systems and technologies have increased the ability for people to connect. In addition, these modern communication systems also empower businesses and companies to broaden their customer reach. One advantage that modern communication systems provide to people and businesses alike is the ability to communicate in real-time. For example, by communicating with customers in real-time, a business can quickly resolve a customer's concern as well as notify customers of promotions and offers that the business is providing. Despite these and other advantages, however, modern communication systems suffer from a number of drawbacks.

As one drawback, the ease by which a business can contact customers (including potential customers) has created numerous customer issues and problems. Previously, the cost for businesses to reach a large number of customers, from sending out a mailer or making phone calls, was expensive and often took a long time. Modern communication systems, however, have drastically reduced the cost and speed of communicating with customers. Because of these reduced costs and increased speeds, many businesses overstep their bounds in contacting customers.

In particular, because modern communication systems make communicating with customers easier, many businesses contact customers without the customers knowingly or directly granting the business permission to contact them. This problem is exacerbated when the unsolicited contact occurs using the customer's private contract information. For example, customers become frustrated when a business calls the customer's mobile device without the customer expressly granting the business permission to use their mobile device.

In other cases, even if a customer grants a business permission to contact the customer, because the cost to contact the customer has become minimal, the business sometimes contacts the customer too frequently. For example, the business might send daily e-mail to the user. Because of the frequent contact, the customer might become frustrated with the business, which can lead to the customer blocking all future communication from the business, viewing the business negatively, and avoiding contact (e.g., physical and digital) with the business.

A further problem that modern communication systems create is, due to the ease of sending communications, customers receive too many communications from businesses. In one or more cases, communications from businesses can inundate a potential customer. As a result, customers might not see a communication or might not read a communication until it has become stale or outdated. For example, by the time a customer views a communication announcing a sale, the sale may have passed, thereby preventing the user from taking advantage of the sale. This can result in disappointment or dissatisfaction for the customer, and wasted opportunities for the business.

These and other disadvantages exist with respect to promoting businesses through modern communication systems and technologies.

### SUMMARY

Embodiments of the present disclosure provide benefits and solve one or more of the preceding or other problems in the art by employing systems and methods that efficiently provide promotional messages to customers via an electronic messaging system. In particular, the disclosed system identifies users (e.g., customers and potential customers) to include in a customized audience based on users of the electronic messaging system who previously communicated with an online merchant (e.g., business, company, page owner, etc.). Additionally, the disclosed system analyzes activity patterns of users to improve delivery of promotional messages via the electronic messaging system. As a result, the disclosed system delivers promotional messages to users via an electronic messaging system in the customized audience in a non-intrusive, private, and timely manner, which leads to improved user experiences with a merchant.

To further illustrate some of the advantages of the present invention, in one or more embodiments, disclosed systems and methods intelligently detect which users of an electronic messaging system to include in a customized audience associated with a merchant. In particular disclosed system identifies users who have previously communicated with the merchant and who are willing to accept communications from the merchant. Further, the disclosed system can dynamically add and remove users of the electronic messaging system to/from the customized audience based upon each user's ongoing actions within the electronic messaging system.

Additionally, one or more example embodiments described herein include the disclosed system determining an optimal delivery time to deliver promotional messages to users in the customized audience. Specifically, the disclosed systems and methods analyze activity patterns of users and determine predicted behaviors of the users. Based on the predicted behaviors, the disclosed system intelligently identifies (e.g., predict) a delivery non-intrusive time. As such, the disclosed system can deliver promotional messages to users in a manner that does not interrupt, annoy, or frustrate users.

Further, in some embodiments, the disclosed system provides increased privacy to users receiving promotional messages. To illustrate, the disclosed system delivers promotional messages to users in a customized audience on behalf of a merchant as part of a targeted (e.g., all users that have a particular set of characteristics) promotional campaign. At the time of delivery, however, the disclosed system does not reveal the identities of the recipient users to the merchant because doing so would directly expose too much personal information to the merchant about each user (e.g., disclosing the messages would directly indicate that each user has the particular set of characteristics). Rather, the disclosed system reveals the identity of a user upon the user responding to the promotional message and electing to continue communications with the merchant. Thus, the user is not directly tied to a targeted promotional campaign. As such, the disclosed system provides increased privacy to users of the electronic messaging system.

In addition, in one or more embodiments, the disclosed systems and methods provide dynamic delivery of promotional messages to users of the electronic messaging system. In particular, the disclosed system delivers a promotional message to a user via the electronic messaging system. The disclosed system monitors the user's interactions with the electronic messaging system of the promotional message for a period (e.g., for an amount of time or upon an event occurring). If the user does not engage with the promotional message during the period, the disclosed system revokes the promotional message. As such, the disclosed system prevents unnoticed or unwanted promotional messages from annoying users.

Additional features and advantages will be outlined in the description that follows, and in part will be obvious from the description, or may be learned by the practice of such exemplary embodiments.

### BRIEF DESCRIPTION OF THE DRAWINGS

To better describe the manner in which the systems and methods obtain the advantages and features of the disclosed embodiments, a number of example embodiments will be described in connection with accompanying drawings. It should be noted that the drawings are not drawn to scale. Further, for illustrative and explanation purposes, elements of similar structure or function are commonly represented by like reference numerals throughout the figures.

FIG. 1 illustrates an example embodiment of a communication environment in accordance with one or more embodiments described herein.

FIG. 2 illustrates a sequence diagram for creating a customized audience in accordance with one or more embodiments described herein.

FIGS. 3A-3C illustrate views of an example graphical user interface for creating a customized audience in accordance with one or more embodiments described herein.

FIG. 4 illustrates a flowchart of a method for creating a customized audience in accordance with one or more embodiments described herein.

FIG. 5 illustrates a sequence diagram for delivering a promotional message to a user at a delivery time based on predicted behavior in accordance with one or more embodiments described herein.

FIG. 6 illustrates an example graphical user interface showing a list of communication threads for a user including a promotional communication thread in accordance with one or more embodiments described herein.

FIG. 7 illustrates a flowchart of a method for delivering a promotional message to a user at a delivery time based on predicted behavior in accordance with one or more embodiments described herein.

FIG. 8 illustrates a sequence diagram for determining when to reveal to a merchant that a promotional message was sent to a user in accordance with one or more embodiments described herein.

FIGS. 9A-9D illustrate example graphical user interfaces of a user engaging with a promotional message in accordance with one or more embodiments described herein.

FIGS. 10A-10B illustrate example graphical user interfaces showing a list of communication threads for a merchant in accordance with one or more embodiments described herein.

FIG. 11 illustrates a flowchart of a method for revealing a promotional message to the merchant in accordance with one or more embodiments described herein.

FIG. 12 illustrates a sequence diagram for revoking a promotional message in accordance with one or more embodiments described herein.

FIG. 13 illustrates an example graphical user interface of merchant insights provided to a merchant in accordance with one or more embodiments described herein.

FIG. 14 illustrates a flowchart of a method for revoking a promotional message in accordance with one or more embodiments described herein.

FIG. 15 illustrates a schematic diagram of a promotional messaging system in accordance with one or more embodiments described herein.

FIG. 16 illustrates a block diagram of a computing device in accordance with one or more embodiments described herein.

FIG. 17 illustrates a network environment of a social networking system in accordance with one or more embodiments described herein.

FIG. 18 illustrates an example social graph of a social networking system in accordance with one or more embodiments described herein.

### DETAILED DESCRIPTION

The embodiments disclosed herein describe a promotional messaging system that improves communication between a merchant and users via an electronic messaging system. More specifically, the promotional messaging system provides improved delivery of promotional messages from the merchant to users via the electronic messaging system. For example, the promotional messaging system creates a customized audience that includes users of an electronic messaging system that have previously communicated with the merchant through the electronic messaging system. Further, the promotional messaging system intelligently determines an ideal time, based on predicted behavior, to deliver promotional messages to users of the customized audience. In another example, the promotional messaging system provides increased privacy to users that receive promotional messages. Additionally, the promotional messaging system revokes promotional messages unnoticed or unwanted by a user and replaces them with messages better suited to the user.

In various embodiments disclosed herein, the promotional messaging system delivers (e.g., pushes), on behalf of the merchant, promotional messages to targeted users in a customized audience such that the messages are timely, non-intrusive, and private. Further, the promotional messaging system ensures that promotional messages remain relevant to a user. As a result, users that receive promotional messages are more receptive and their customer satisfaction with the merchant increases.

As mentioned above, in one or more embodiments, the promotional messaging system creates a customized audience selected from users on an electronic messaging system. In particular, a merchant requests a customized audience to whom to send promotional messages. In response, the promotional messaging system analyzes users of the electronic messaging system to identify the users that have previously communicated with the merchant via electronic message. Using the identified users, the promotional messaging system creates a customized audience for the merchant. Further, the promotional messaging system continues to monitor user activity to determine whether users should be added to or removed from the customized audience created for the merchant.

When sending a promotional message to a user in a customized audience, in some embodiments, the promotional messaging system predicts when the user will become active (e.g., login or read messages) based on past activity of the user. Using the predicted behavior, the promotional messaging system can determine a delivery time for the promotional message that is not interruptive, annoying, or frustrating to the user. To determine an optimal delivery time, the promotional messaging system analyzes a user's activity patterns within the electronic messaging system. Based on the analysis, the promotional messaging system identifies a predicted behavior. Using the predicted behavior, the promotional messaging system determines a delivery time for the promotional message, such as just before or just after the occurrence of the predicted behavior.

In various embodiments, the promotional messaging system protects privacy information of users that receive promotional messages. As mentioned above, the promotional messaging system delivers promotional messages to users on behalf of a merchant. Due to the nature of electronic messages (or simply “messages”), messages are sent to specific people. Thus, if the merchant sends a promotional message to a targeted group of users (e.g., Caucasian females of age x and income y), the personal identities of each user in the group of users are coupled with the matching characteristics. Accordingly, the promotional messaging system hides a promotional message from the merchant until a recipient user responds to the message. As such, the merchant is unaware of which targeted characteristics apply to the recipient user, and thus, the user's privacy is protected.

In one or more embodiments, the promotional messaging system ensures that users only engage with relevant (e.g., non-stale) promotional messages. In particular, upon delivering a promotional message to a user, the promotional messaging system monitors the user's interaction with the message for a period (e.g., a time period or other metric). If the user does not engage with the promotional message during the period, the promotional messaging system revokes the message. For example, the promotional messaging system can send a delete command removing the message from the user's messages. Thus, by revoking messages that the user fails to engage with, the promotional messaging system prevents the user from viewing stale messages containing expired or old offers, which often annoys or disappoints users.

In some embodiments, upon revoking the message, the promotional messaging system replaces the message with a new or more relevant promotional message. For example, upon revoking a promotional message, the promotional messaging system delivers a similar but updated promotional message. Alternatively, upon revoking a promotional message from one merchant, the promotional messaging system delivers a promotional message from another merchant.

Furthermore, the promotional messaging system benefits a merchant by revoking messages. For example, when a user viewed a stale or outdated message, the action counts as a user impression against a merchant. However, when a message is revoked, users cannot engage with those messages and, thus, impressions are not counted against a merchant. In this manner, the promotional messaging system prevents delayed impressions that count against a merchant with no benefit to the merchant.

In addition to the foregoing, the promotional messaging system provides a number of additional advantages over modern communication systems and communication technologies. For example, the promotional messaging system delivers promotional messages via an electronic messaging system to users in a customized audience who invite messages from the merchant. Further, as described further below, the promotional messaging system provides promotional messages to users in the customized audience in a manner that is discrete, does not interrupt the user's daily activities, protects the user's privacy, and prevents user frustration. These and other advantages are discussed in more detail with respect to the figures.

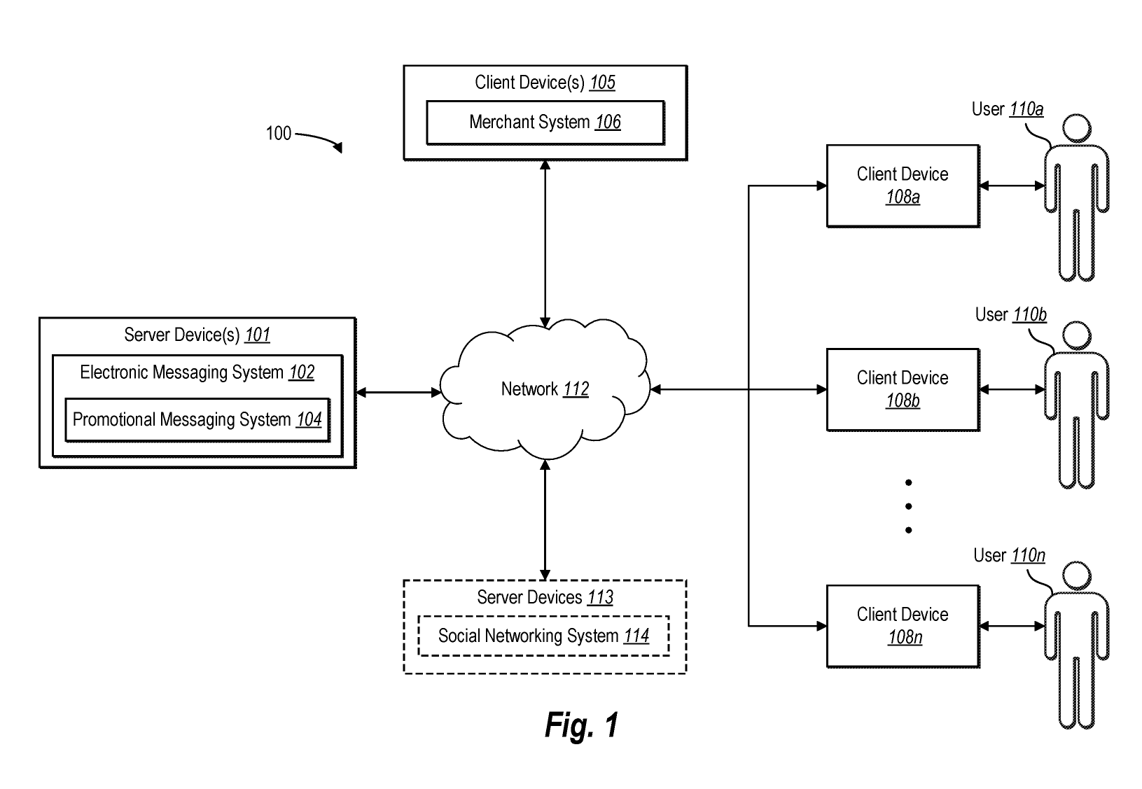

FIG. 1 illustrates an example embodiment of a communication environment 100 that can be used with one or more example embodiments of a promotional messaging system 104. As shown, the communication environment 100 includes a number of device(s) that host various systems and services. For example, the one or more server device(s) 101 host an electronic messaging system 102 that includes the promotional messaging system 104 and the one or more client device(s) 103 host a merchant system 106, which is associated with a merchant. Further, the communication environment 100 also includes multiple client devices 108a-n, which are associated with corresponding users 110a-n. In some embodiments, each of the client devices 108a-n includes a client-based messaging application that facilitates sending and receiving messages.

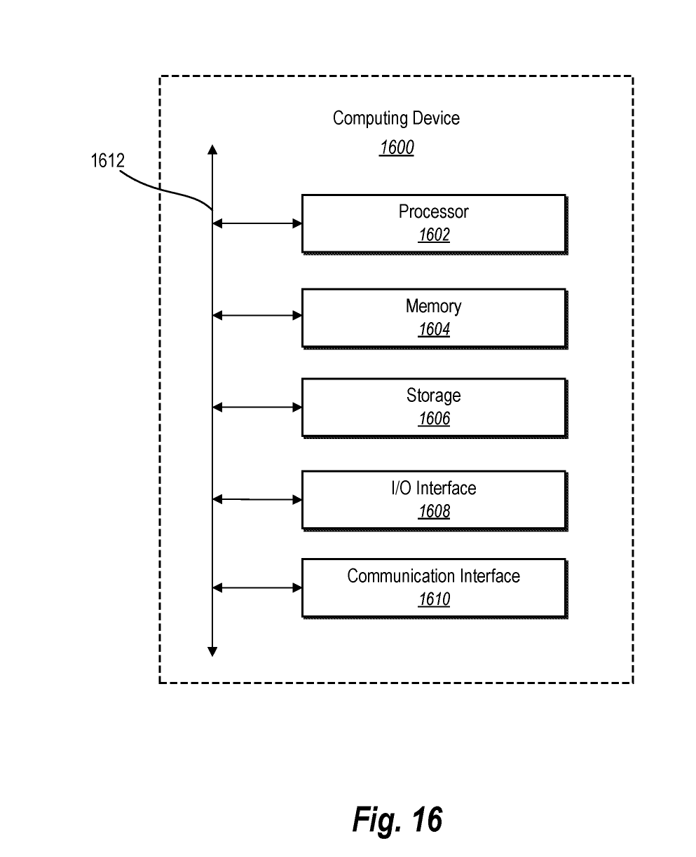

As illustrated in FIG. 1, the one or more server device(s) 101 hosting the electronic messaging system 102 and the promotional messaging system 104, the one or more client device(s) 103 hosting the merchant system 106, and the client devices 108a-n communicate with each other via the network 112. Although FIG. 1 illustrates a particular arrangement of the various components within the communication environment 100, various additional arrangements are possible. For example, the merchant system 106 may be implemented on one or more server device(s) rather than the one or more client device(s) 103. As another example, the promotional messaging system 104 operates independently of the electronic messaging system 102. Additional detail regarding the various computing devices and networks are explained below with respect to FIG. 16.

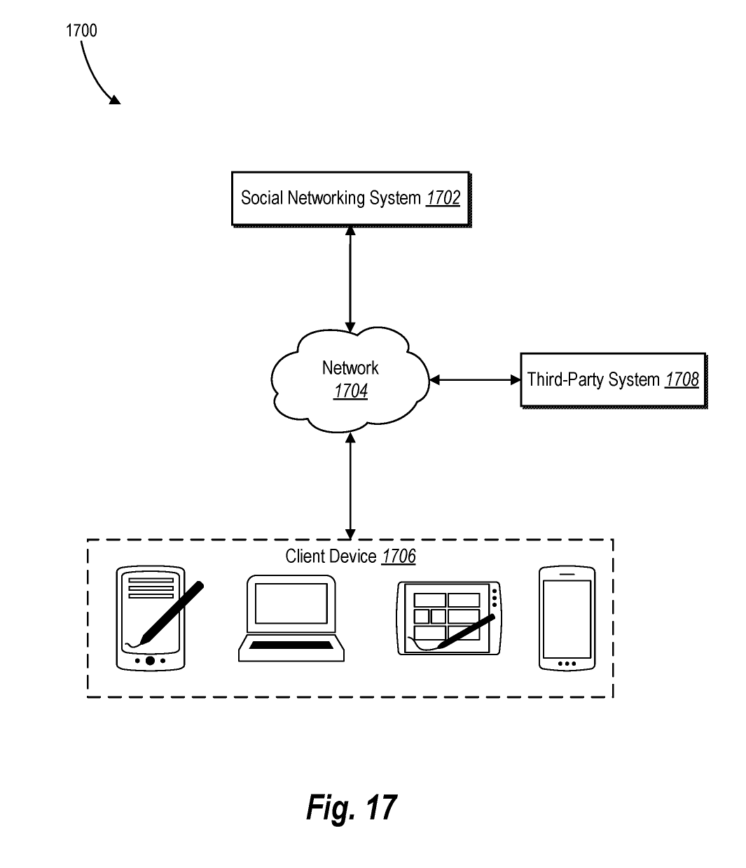

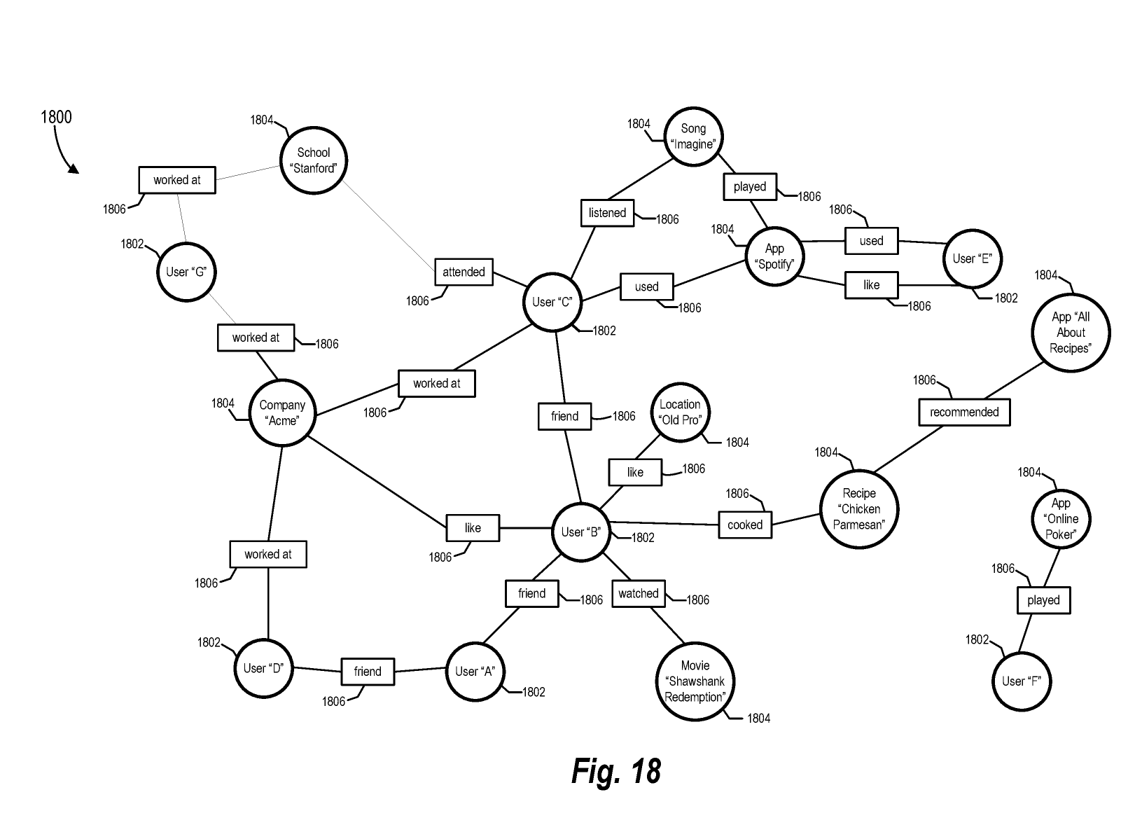

In some embodiments, the communication environment 100 includes a social networking system 114. As such, FIG. 1 illustrates an optional social networking system 114 implemented on one or more server device(s) 113. The social networking system 114 can connect the users 110a-n (and the merchant) together via various interests, people connections, and groups. Additional information regarding the social networking system 114 is provided below in connection with FIGS. 17-18.

In one or more embodiments, the electronic messaging system 102 operates within or in connection with the social networking system 114. For example, the social networking system 114 host both the electronic messaging system 102 and the promotional messaging system 104. In this example, the merchant may manage a social networking page within the social networking system 114 (e.g., the merchant is a page owner within the social networking system 114). In particular, one or more administrators can mange the profile/page of the merchant using the client device(s) 105. Further, an administrator, via the client device(s) 105, can use the promotional messaging system 104 to perform promotional campaigns to users of the social networking system 114.

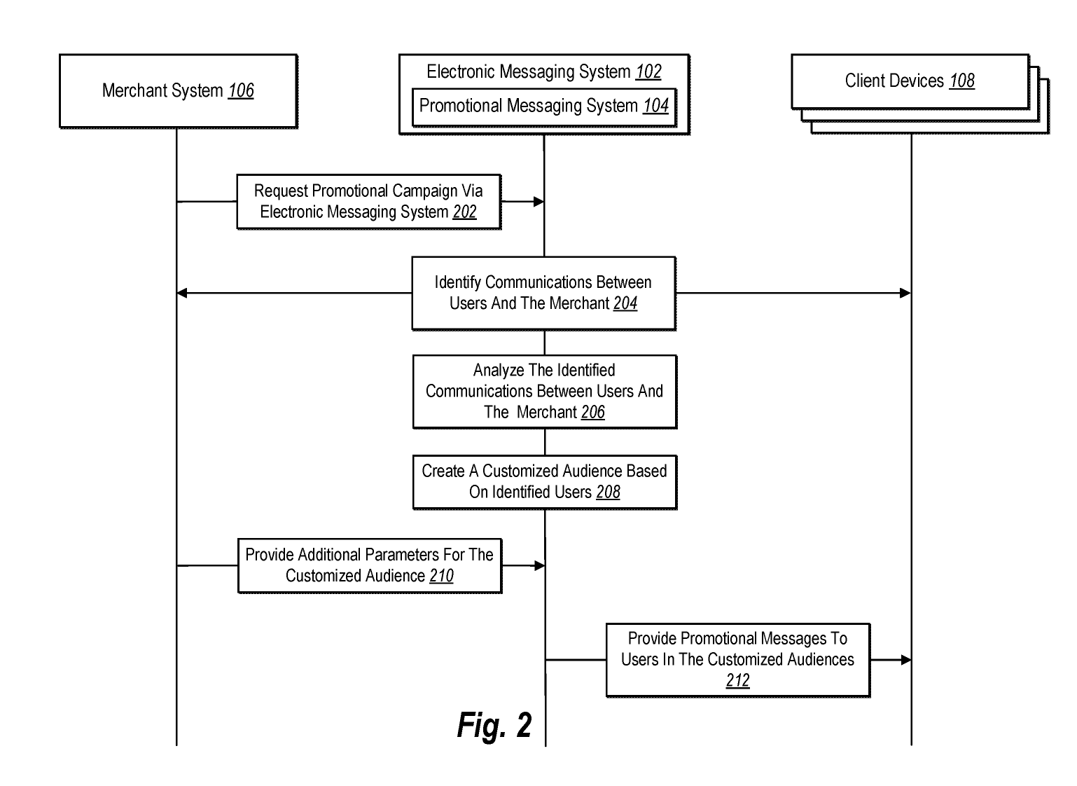

As mentioned above, and as shown in FIG. 1, the communication environment 100 includes the promotional messaging system 104 as part of the electronic messaging system 102. As a brief overview, the promotional messaging system 104 improves delivery of promotional messages to users in a customized audience who are selected from the user 110a-n. For example, if a first user 110a and a second user 110b have previously communicated with the merchant via the electronic messaging system 102, the promotional messaging system 104 includes the first user 110a and the second user 110b in a customized audience for a promotional campaign on behalf of the merchant. Additional details concerning the promotional messaging system 104 creating a customized audience will be described further below with respect to FIGS. 2-4.

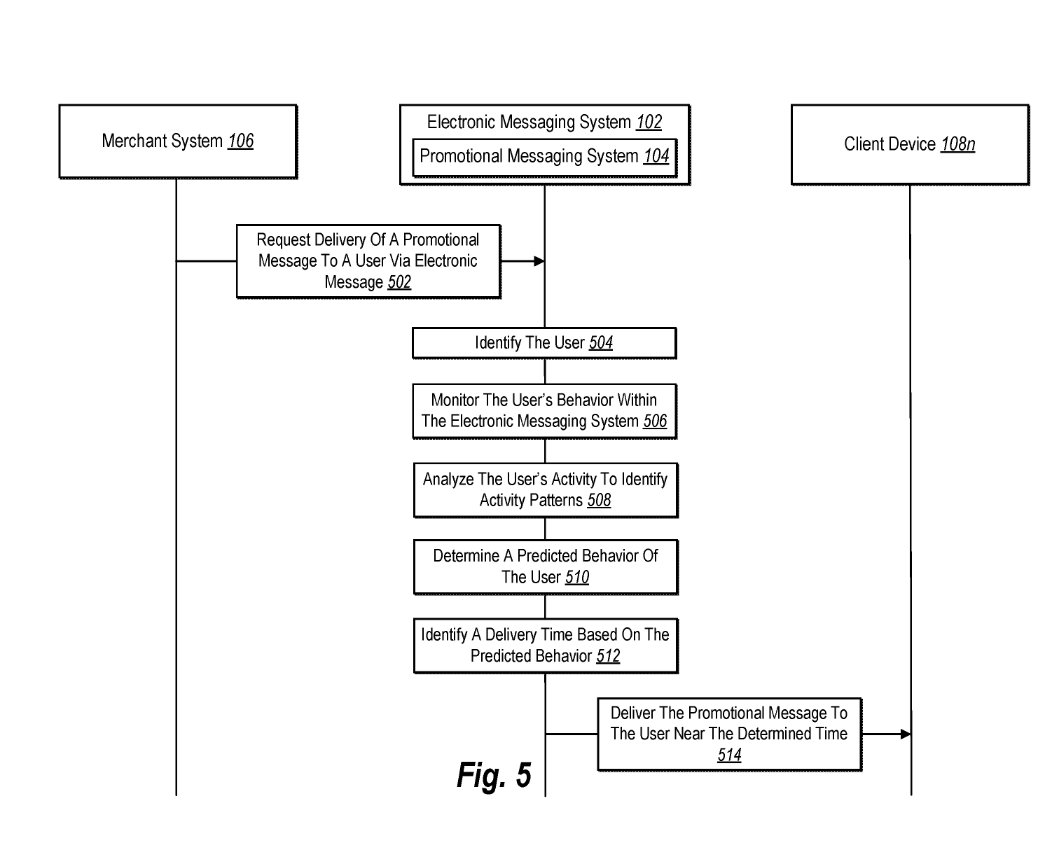

In some embodiments, the promotional messaging system 104 sends a promotional message to a client device of a user. For example, the promotional messaging system 104 pushes a promotional message in the form of an electronic message to the first user 110a via a first client device 108a. In delivering the promotional message, the promotional messaging system 104 analyzes activity patterns of the first user 110a within the electronic messaging system 102 and determines an optimal delivery time based on a predicted behavior of the first user 110a. Additional details regarding the promotional messaging system 104 determining an optimal delivery time will be described further below with respect to FIGS. 5-7.

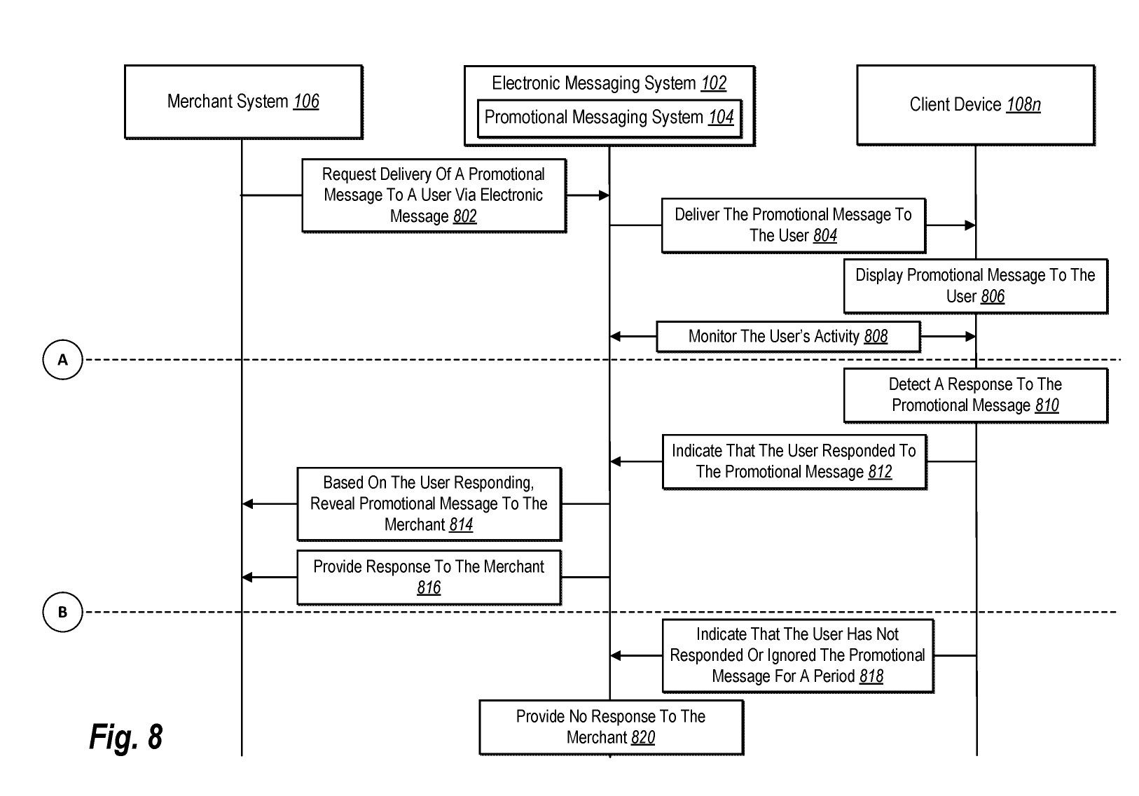

In one or more embodiments, the promotional messaging system 104 delivers a promotional message to a user (e.g., a user's inbox). The promotional messaging system 104 monitors the user's interactions with the promotional message. Before the user responds to the promotional message, the promotional messaging system 104 hides the sent promotional message from the merchant. However, upon the user responding to the promotional message, the promotional messaging system 104 reveals the promotional message to the merchant via the merchant system 106. Further, the promotional messaging system 104 can also provide the user's response to the to the merchant via the merchant system 106. Additional details regarding the promotional messaging system 104 hiding and revealing promotional messages from the merchant will be described further below with respect to FIGS. 8-11.

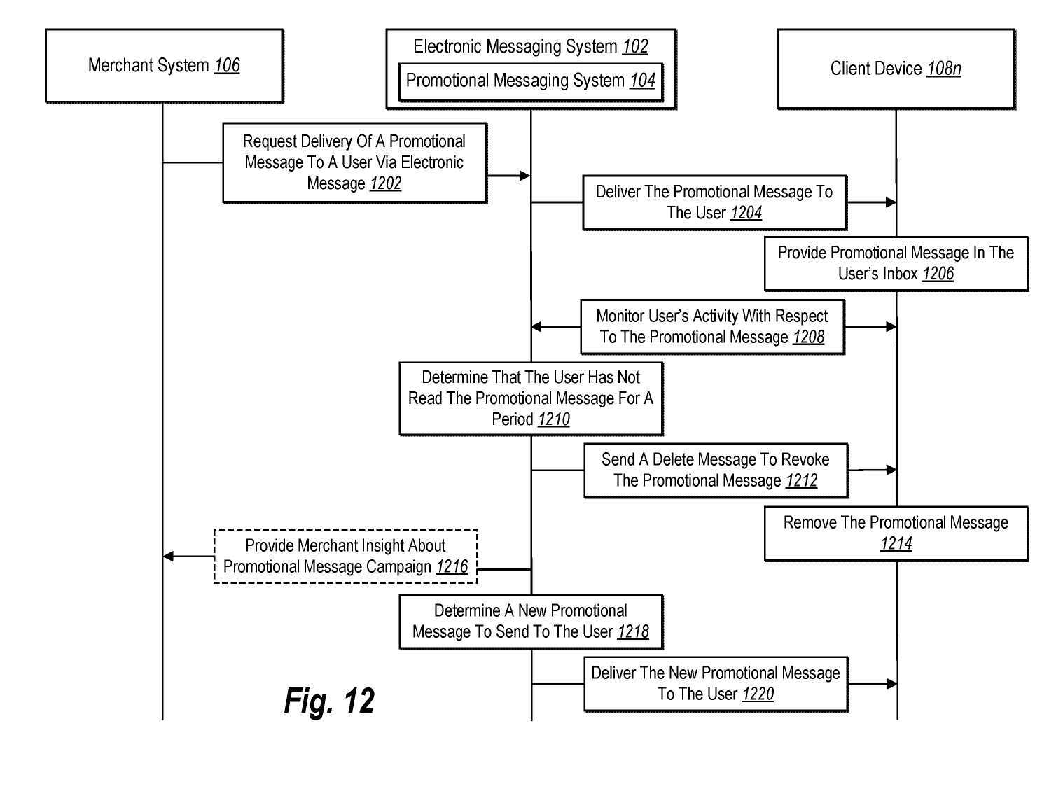

In some embodiments, the promotional messaging system 104 revokes a promotional message sent to a user. For instance, upon sending a promotional message to a user, the promotional messaging system 104 monitors the user's interactions with the promotional message. If the user does not engage with the promotional message for a period, the promotional message revokes the message. Additional details of the promotional messaging system 104 revoking a promotional message from a user will be described further below with respect to FIGS. 12-14.

As used herein, the term “promotional message” generally refers to an electronic message that contains information associated with and promoting a merchant. A promotional message often includes an offer, such as an advertisement, for a product or service offered by the merchant. For example, a promotional message can include a discount on products offered by the merchant with an expiration date of one week. Further, promotional messages, as used herein, are largely sent via the electronic messaging system. In some instances, the electronic messaging system can be tied to or a part of a social networking system. Additionally, the promotional messaging system can send promotional messages on behalf of a merchant.

As used herein, the term “merchant” refers to a commercial entity that provides goods and/or services. In general, one or more administrators for the merchant operate the merchant system. In many embodiments, the merchant is affiliated with a social networking system. For example, the merchant maintains a social networking profile. In another example, the merchant is a page owner of a social networking page that advertises, promotes, and/or sells one or more products by way of the social networking system. Alternatively, the merchant system may be a third-party system that is separate from and independent of the social networking system. Examples of merchants include, but are not limited to, merchants providing a specific category of product, merchants providing a broad variety of products, and merchants having virtual stores, and merchants having both physical and virtual stores.

As used herein, the term “electronic messaging system” generally refers to a communication system that facilitates exchange of electronic messages between users. Examples of an electronic messaging system include, but are not limited to, an instant message system, an email system, a text message system, a short message service (SMS) system, a video messaging system, a streaming message system, and other electronic messaging systems. In general, messages sent via the electronic messaging system are “pushed” or forwarded to a client-based messaging application on the client device associated with a user, rather than “pulled” or fetched to the client device.

FIG. 2 illustrates a sequence diagram promotional messaging system for creating a customized audience. As shown, FIG. 2 includes the electronic messaging system 102, the promotional messaging system 104, the merchant system 106, and the client devices 108a-n (hereafter referred to as “client devices 108”). The promotional messaging system 104, the electronic messaging system 102, the merchant system 106, the electronic messaging system 102, and the client devices 108a-n can be the same or similar to those described with respect to FIG. 1. For example, the electronic messaging system 102 can be located on the one or more server device(s) 101 and the merchant system 106 can be located on the one or more client device(s) 103.

The term, “customized audience,” as used herein generally refers to a subset of users within the electronic messaging system. The promotional messaging system creates one or more customized audiences for each merchant participating in one or more promotional campaigns. Thus, multiple customized audiences may be associated with a single merchant. In general, a customized audience includes users that have previously messaged the merchant. Additional detail regarding customized audiences is provided below.

In one or more embodiments, and as illustrated in FIG. 2, the promotional messaging system 104 communicates with the merchant system 106 and the client devices 108. As shown in step 202, the merchant, via the merchant system 106, requests to initiate (or modify) a promotional campaign (or to send other types of communications) via the electronic messaging system 102. Specifically, the merchant exchanges communications with the promotional messaging system 104 to create a promotional campaign via the electronic messaging system 102. For example, a merchant using the merchant system 106 can navigate through a promotional management application provided by the promotional messaging system 104 to set up, modify, and run a targeted promotional campaign (e.g., a campaign targeted at a specific group of users) via the electronic messaging system 102.

As part of creating a promotional campaign, the promotional messaging system 104 creates a customized audience. In particular, and as shown in step 204, the promotional messaging system 104 identifies messages (within the electronic messaging system 102) between users of the electronic messaging system 102 and the merchant. In some embodiments, the promotional messaging system 104 only identifies active communication threads. As used herein, the term “communication thread” refers to a series of electronic messages between two users of the electronic messaging system 102. A communication thread can be between a user and the merchant, or a communication thread can be between multiple users. In some instances, a communication thread includes one or more messages sent by one party to another party before the other party has responded.

In some embodiments, the promotional messaging system 104 maintains one or more list of users that have communicated with the merchant via the electronic messaging system 102. For example, if a user first sends a message to the merchant, the promotional messaging system can flag the user and add them to a merchant contact list. In another example, a user can opt-in to receive communications from the merchant via the electronic messaging system 102 and the promotional messaging system 102 can add the merchant to the list. As mentioned below, a user on the list can directly or indirectly ask to be removed from a message contact list. Using the one or more lists, the promotional messaging system can 104 identify users that have send messages to the merchant.

As mentioned above, the promotional messaging system 104 may identify active communication threads. In some embodiments, an active communication thread includes a communication thread that has not been hidden or deleted from either party's list of communication threads. In some cases, an active communication thread includes a message that is less than a threshold age (e.g., a week, 15-days, a month, six months, a year, etc.) from the delivery timestamp of the message. Additionally, or in the alternative, an active thread may include a communication thread that is pending a response from the other party (e.g., the last electronic message in the communication thread includes a question).

Upon identifying communications between users and the merchant, the promotional messaging system 104 analyzes the identified communications between users and the merchant, as step 206 illustrates. In particular, the promotional messaging system 104 can analyze communications between users and the merchant within the electronic messaging system 102 to identify communications where users have sent messages to the merchant.

A user can send communications to the merchant in numerous ways. For example, a user sends an electronic message to the merchant via a client device. For instance, the user initiates a conversation by sending a message (e.g., instant message, email, text message, chat message, social media message, etc.) to the merchant asking about a product or commenting on a recent experience. Alternatively, the user can use the electronic messaging system 102 to reply to the merchant within a communication thread.

As another example, the user consents to receive communications from the merchant. For instance, the user indicates to the merchant that he or she would like to receive digital receipts from the merchant via the electronic messaging system 102. Further, the user may select an option to receive offers, solicitations, updates, and/or other information from the merchant via the electronic messaging system 102.

In some embodiments, the promotional messaging system 104 identifies if an existing relationship exists between a user and the merchant. For example, the promotional messaging system 104 determines whether a user has previously communicated with the merchant via systems other than the electronic messaging system 102. For instance, the promotional messaging system 104 identifies whether the user has posted on a social media page associated with the merchant, and/or if the merchant has responded to the user via social media. In another instance, the promotional messaging system 104 can determine whether the user is part of a membership or loyalty program associated with the merchant and whether the user has elected to receive electronic communications from the merchant.

In one or more embodiments, the electronic message system 102 tracks and analyzes with which communication media a user interacts with the merchant. For example, the merchant participates in a promotional campaign that provides promotional messages via Internet websites, email, and text messages. When a user selects a promotional message, the electronic message system can save a campaign identifier (e.g., campaign_id) indicating both the promotional message and the communication medium used by the user to select the promotional message. The electronic message system 102 can use this information as part of determining whether to include the user in a customized audience and/or to target the user in a more intelligent manner based on past promotional campaigns, in which the user expressed interest or participated. For example, the electronic message system 102 can take into account where the user found the promotional message when further communicating with the user regarding the promotion of interest to the user. Further, in some embodiments, selecting the promotional message prompts the user to add and/or communicate with the merchant via the electronic message system 102. For instance, upon the user selecting a promotional message, regardless of the communication media used to select the promotional message, the electronic message system 102 directs the user to a communication thread with the merchant via the electronic message system 102.

In addition, in some embodiments, the electronic message system 102 receives information regarding a user's ongoing communication session with the merchant and utilizes that information to seamlessly continue that communication. For example, if the user is shopping on the merchant's website or is in the middle of checking out when the user is redirected to the electronic message system 102, the electronic message system can maintain that information—using an identifier, such as a session id—and either use the information in communications with the merchant or pass the information on to an administrator for the merchant to facilitate communication by the administrator with the user through the electronic message system 102. Additional information regarding this and other topics disclosed here is disclosed in U.S. patent application Ser. No. 15/288,723, “REENGAGING WEBSITE VISITORS WITH SOCIAL NETWORKING SYSTEM ELECTRONIC MESSAGES,” which is incorporated herein by reference in its entirety.

Based on identified communications or other interactions between users and the merchant, the promotional messaging system 104 can create a customized audience. As shown in step 208, the promotional messaging system 104 creates a customized audience for the promotional campaign based on the identified users. In other words, the promotional messaging system 104 includes users that have previous communications with the merchant in a customized audience. In this manner, each user in the customized audience has communicated with the merchant via the electronic messaging system 102 and has indicated some level of willingness to receive further communications, such as promotional messages, from the merchant.

In some embodiments, the promotional messaging system 104 applies additional criteria when creating a customized audience. For example, as mentioned above, the promotional messaging system 104 requires that previous communications between users and the merchant correspond to active communication threads before being included in a customized audience. As such, the promotional messaging system 104 may limit the users in a customized audience to users that have recently engaged with the merchant.

As another example, the promotional messaging system 104 can analyze communications between users and the merchant to identify exchanges that include positive or negative sentiment. For instance, the promotional messaging system 104 includes users that express positive sentiment with the merchant in the customized audience but leave out users that express negative sentiment (e.g., problems, complaints, frustrations, etc.) In some embodiments, the promotional messaging system 104 may only exclude a user from the customized audience if communications between a user and the merchant include negative sentiment that recently occurred (e.g., in the past week, month, two months, six months, etc.). Otherwise, if a threshold amount of time or waiting period has passed since the negative sentiment, the promotional messaging system 104 includes the user in the customized audience. In some cases, if the communication thread shows positive sentiment occurring more recently than the negative sentiment (e.g., the merchant resolved the issue or the user has since had a positive experience), the promotional messaging system 104 includes the user in the customized audience.

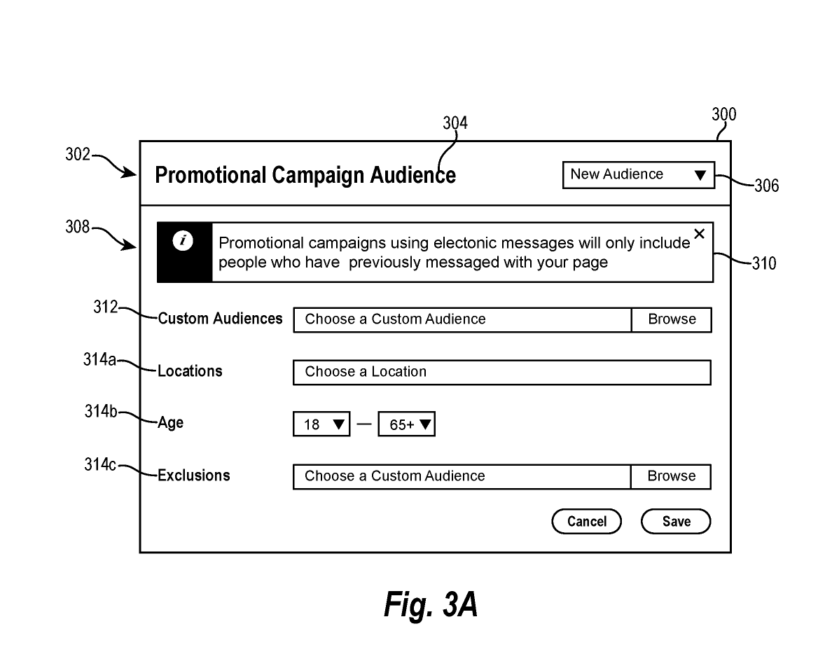

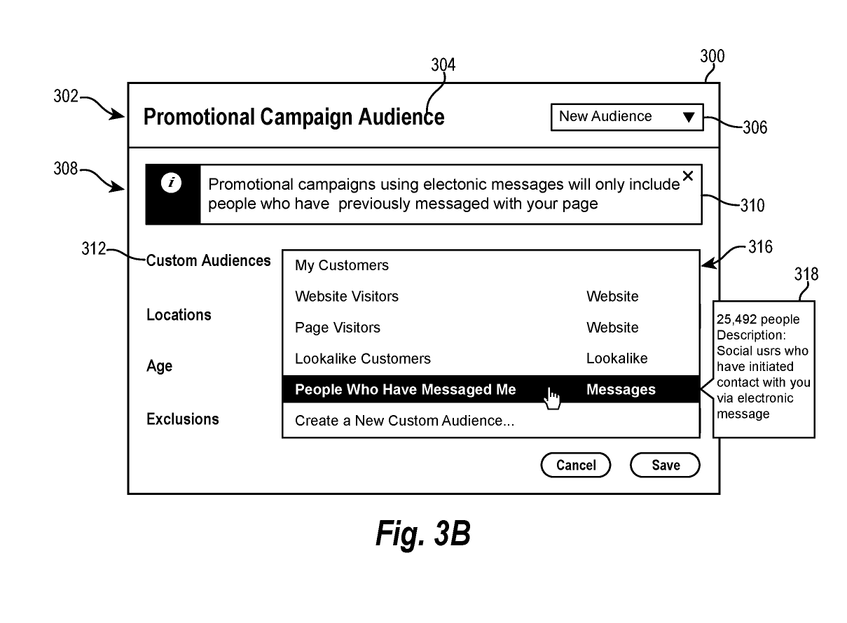

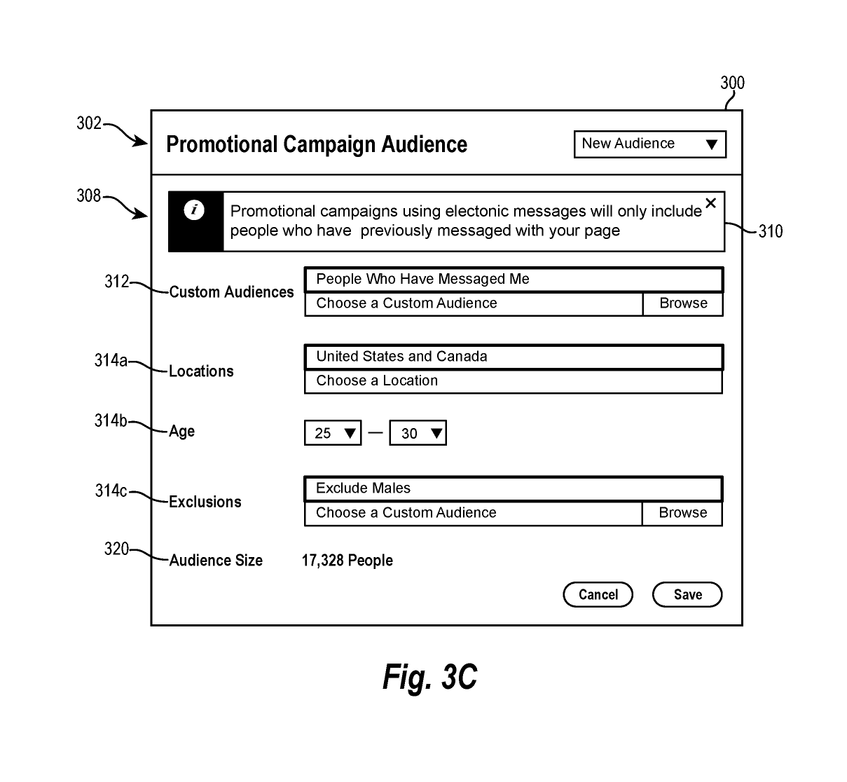

In step 210, the merchant, via the merchant system 106, provides additional parameters for the customized audience. For example, the merchant provides parameters to tailor the customized audience to a targeted group of users. Additional details are provided in connection with FIGS. 3A-3C with respect to narrowing a customized audience to a particular group of users within the electronic messaging system 102.

Upon creating the customized audience for a promotional campaign, the promotional messaging system 104 provides the promotional messages to users in the customized audience, as step 212 illustrates. For example, the promotional messaging system 104 can individually deliver promotional messages to each user in the customized audience. In some instances, the promotional messaging system 104 customizes each promotional message, such as by including the name of the user in the promotional message and/or uses pronouns suited for the gender of the user.

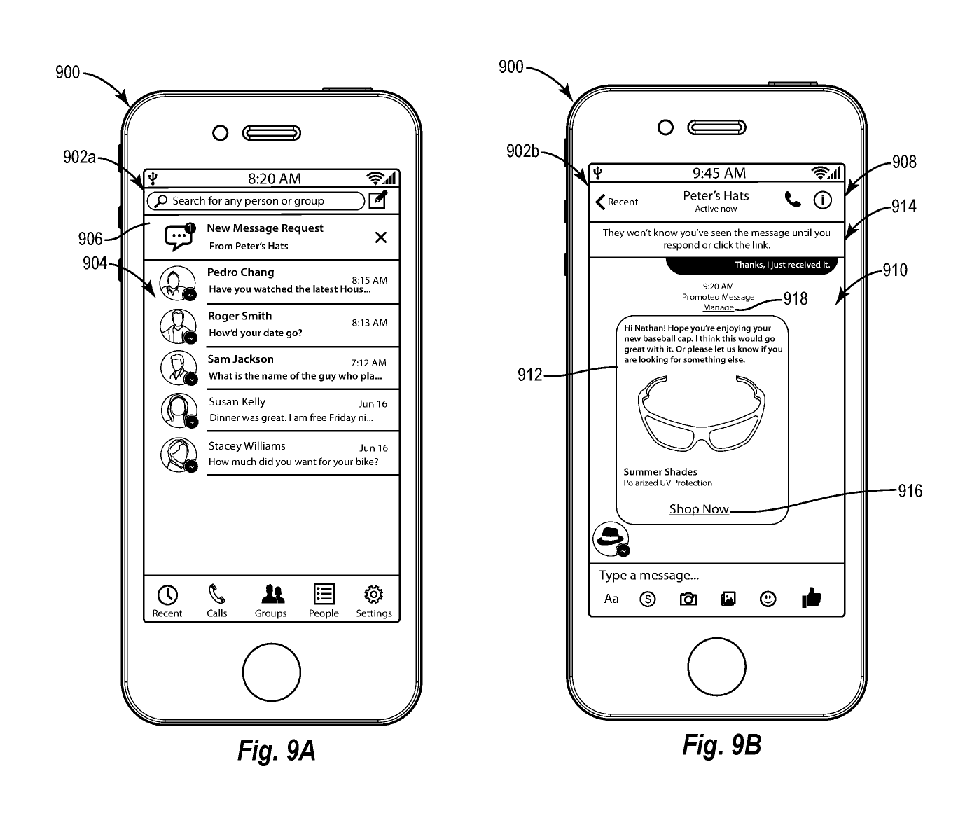

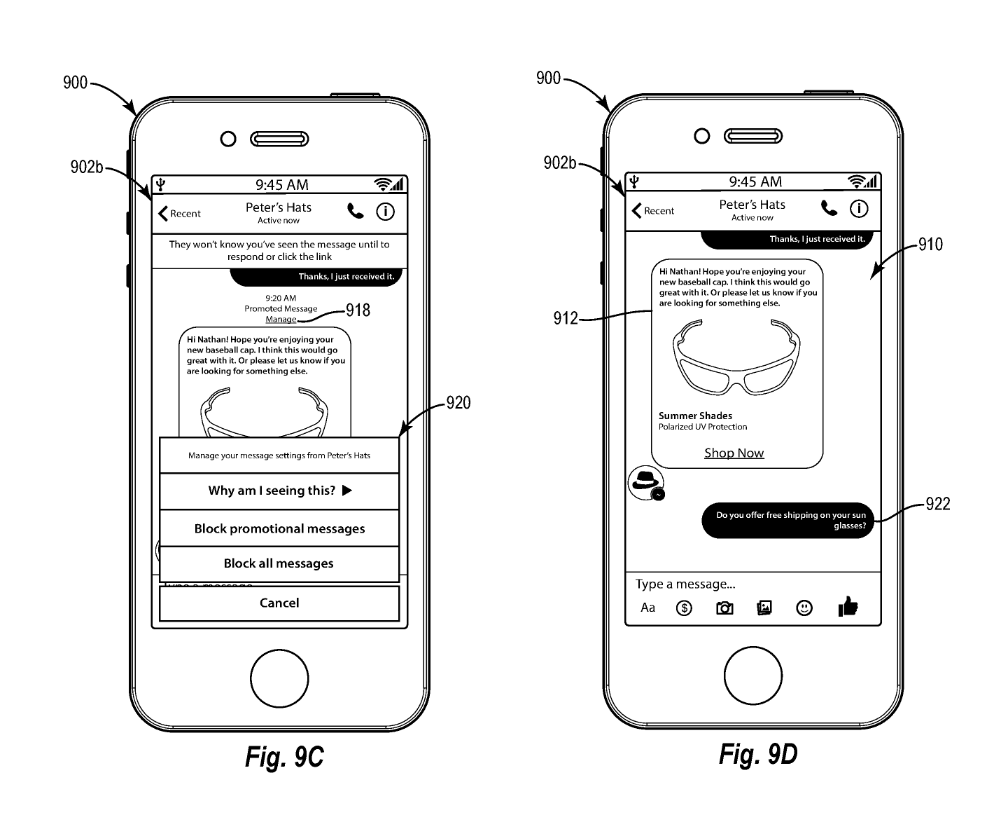

In one or more embodiments, a user that receives a promotional message indicates a desire to stop receiving promotional messages. For example, the user blocks the promotional message, replies with a stop message, or otherwise indicates a desire to stop receiving additional promotional messages. In these embodiments, the promotional messaging system 104 removes the user from the customized audience so that the user does not receive additional promotional messages. An example of a user managing their preferences with respect to a promotional message is provided below in connection with FIGS. 9A-9C.

FIGS. 3A-3C illustrate views of an example graphical user interface 300 for creating a customized audience. The promotional messaging system described above provides the graphical user interface 300. In general, the graphical user interface 300 can be part of a promotional management application that enables a merchant to create, modify, and manage promotional campaigns. Further, the promotional messaging system largely provides the graphical user interface 300 to a merchant system, where a merchant views and interacts with the graphical user interface 300. Alternatively, the promotional messaging system can provide the graphical user interface 300 to another client device, which displays the graphical user interface 300.

As shown in FIG. 3A, the graphical user interface 300 includes a header section 302 and a body section 308. The header section 302 includes a title 304 that provides a context to the graphical user interface 300. The header section 302 also includes a drop-down selection menu 306 that allows a merchant to create a new customized audience and/or targeted customized audience from an existing customized audience. One will appreciate that header section 302 can include additional or different components.

The body section 308 includes elements that enable a merchant to create a customized audience and/or refine parameters of users in the customized audience. As illustrated, the body section 308 includes a warning notification 310, a customized audiences selection box 312, and selectable user parameters 314a-c. The warning notification 310 provides the merchant a notification that promotional campaigns via an electronic messaging system only include users who have previously communicated with the merchant. The merchant can close the warning notification 310. Alternatively, the warning notification 310 is fixed within the graphical user interface 300.

In some embodiments, the warning notification 310 appears as a pop-up notification or bubble message upon a user selecting a promotional campaign via the electronic messaging system. For example, upon selecting a type of customized audience from the customized audiences selection box 312, the promotional messaging system displays the warning notification 310 in connection with the graphical user interface 300.

As shown in FIG. 3B, the merchant selects the customized audiences selection box 312. Upon selection, the customized audiences selection box 312 expands to display a list of customized audiences 316. Each option in the list of customized audiences 316 corresponds to a type of promotional campaign. For example, some customized audiences shown are associated with targeting users via a website while other customized audiences focus on lookalike customers. In some cases, a customized audience in the list of customized audiences 316 are filtered or grayed out (e.g., not selectable) when the customized audience is not available for selection (e.g., a customized audience is not available when it conflicts with other options previously selected by the merchant).

As illustrated, the merchant selects the customized audience “People Who Have Message Me,” which corresponds to sending promotional messages via the electronic messaging system (i.e., “Messages”). Upon selecting this customized audience, the promotional messaging system displays an announcement 318 that provides additional information about the customized audience. For example, the pop-up 318 indicating the number and type of users included in the selected customized audience.

In addition to selecting a customized audience, the merchant can provide input for additional parameters that further target a promotional campaign to a specific set of users. For example, as FIG. 3C illustrates, in addition to selecting a customized audience as that includes users that have previously communicated with the merchant via the electronic messaging system, the merchant can select one or more user parameters 314a-c. In particular, the user can specify one or more locations 314a of users. Locations may range from large areas such as groups of countries (e.g., Latin America, Europe, etc.), countries, or regions (east coast, mid-west, the tri-states, etc.) to smaller areas such as cities, states, or neighborhoods.

Also, a merchant can filter users in the customized audience by age 314b. In particular, the merchant selects an age range to target specific users for the promotional campaign. Further, the merchant can provide additional exclusions, such as limiting the promotional campaign to a specific gender, financial bracket, social status, etc. As shown, the merchant has selected the age range of 25-30 and has chosen to exclude males from the customized audience.

As a result of the merchant's selection, the size of the customized audience has shrunk. In particular, the number of users that have previously contacted the merchant via the electronic messaging system and that meet the other user parameters 314a-c has shrunk, as indicated by the audience size of 17,328. By providing the merchant with the size of the customized audience, the merchant can add or remove user parameters 314a-c to reach the desired customized audience size. Once the merchant is satisfied with the customized audience, they can submit (e.g., save) their inputs to the promotional messaging system.

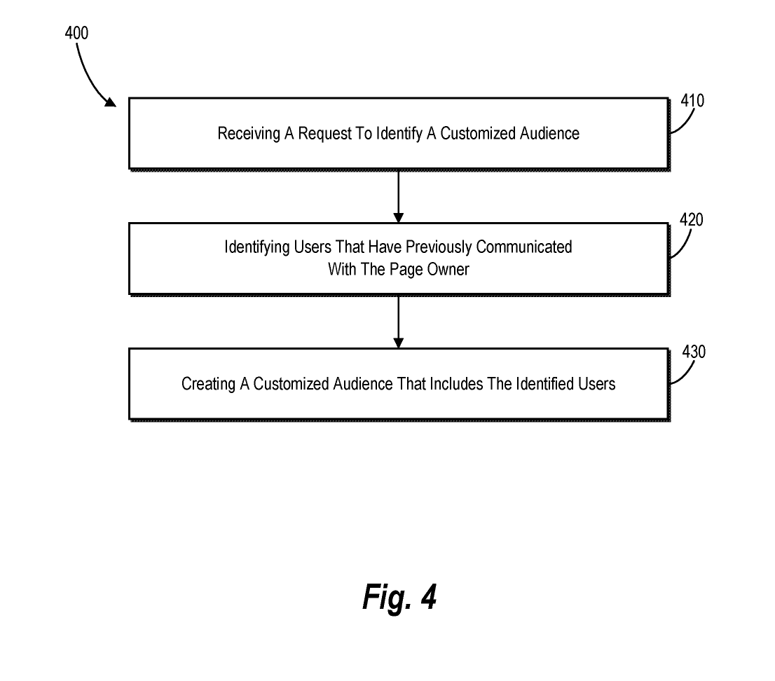

FIG. 4 illustrates a flowchart of a method 400 for creating a customized audience. In one or more embodiments, the promotional messaging system 104 described herein performs the method 400. For example, a promotional messaging system 104 within an electronic messaging system 102, and operating on the one or more server devices 101, performs the method 400. Alternatively, one or more client devices can perform the method 400.

The method 400 includes an act 410 of receiving a request to identify a customized audience. In particular, the act 410 may involve receiving a request, from a page owner (i.e., the merchant), to identify a customized audience of users on an electronic messaging system 102. In one or more embodiments, the act 410 includes facilitating a promotional campaign for the page owner 106. In some embodiments, the page owner 106 is a page owner of a social media page on a social networking system 114.

The method 400 also includes an act 420 of identifying users 312 that have previously communicated with the page owner. In particular, the act 420 involves analyzing users 110a-n of the electronic messaging system 102 to identify a group of users 312 that have previously communicated with the page owner 106 via the electronic messaging system 102. In some embodiments, the act 420 involves identifying users that have initiated contact with the page owner. For example, initiating communications with the page owner may include a user sending an electronic message to the page owner via the electronic messaging system 102. In addition, initiating contact with the page owner may include a user authorizing the page owner to send communications to the user via the electronic messaging system 102. Further, initiating contact with the page owner can include a user purchasing a product or service from the page owner via the electronic messaging system 102. In some embodiments, initiated contact may be nullified if the contact included negative sentiment with respect to the page owner.

Also, the method 400 includes an act 430 of creating a customized audience that includes the identified users 312. In particular, the act 430 involves creating a customized audience that includes the identified group of users 312 that have previously communicated with the page owner 106. In one or more embodiments, the act 430 includes receiving audience parameters from the page owner for the advertisement campaign and filtering users in the customized audience based on the audience parameters. In some embodiments, the act 430 involves adding additional users to the customized audience based on the additional users participating in the electronic messaging system 102 and/or based on the additional users positively interacting with the page owner via a social networking system 114.

The method 400 can also include one or more additional acts. For example, the method 400 includes the act of serving promotional messages to users of the customized audience via electronic messages. In another example, the method 400 includes the act of removing a user from the customized audience upon receiving a request from the user to block promotional messages from the page owner. Further, the method 400 can include the acts of periodically scanning the electronic messaging system 102 for new users that have initiated communications with the page owner and adding the new users to the customized audience.

As mentioned previously, FIGS. 5-7 relate to the promotional messaging system determining an optimal delivery time to deliver a promotional message to a user. In particular, FIG. 5 illustrates a sequence diagram for delivering a promotional message to a user at a delivery time based on a predicted behavior. As shown, FIG. 5 includes the electronic messaging system 102, the promotional messaging system 104, the merchant system 106, and a client device 108n. The electronic messaging system 102, the promotional messaging system 104, the merchant system 106, and the client device 108n can be the same or similar to those described with respect to FIG. 1.

As illustrated in step 502, the merchant requests, via the merchant system 106, delivery of a promotional message to a user via electronic message. For example, the merchant requests that the promotional messaging system 104 send one or more promotional messages, on behalf of the merchant, to one or more users via the electronic messaging system 102. The merchant generally sends the request as part of creating a promotional campaign to deliver promotional messages to users in a customized audience, as provided above. For purposes of explication, FIG. 5 is described with reference to a single user; however, one will appreciate that the concepts and methods described can be expanded to multiple users.

In step 504, the promotional messaging system 104 identifies the user specified in the request. For example, the promotional messaging system 104 determines that the user is associated with a particular user account of the electronic messaging system 102 and/or the client device 108n. As described herein, the user may be one of the users in a customized audience.

Upon identifying the user, the promotional messaging system 104 monitors the user's behavior within the electronic messaging system 102, as shown in step 506. For example, the promotional messaging system 104 monitors the user's activity. In particular, the promotional messaging system 104 can observe each time the user logs in, logs out, sends a message, receives a message, and/or performs other activities on the electronic messaging system 102.

In step 508, the promotional messaging system 104 analyzes the user's activity. In particular, the promotional messaging system 104 analyzes the user's past interactions on the electronic messaging system 102 to identify activity patterns of the user. For example, the promotional messaging system 104 analyzes the user's activity to determine patterns when the user logs in and out, the number of messages sent and received by the user, the time of day that the user is active, the number of contacts with whom the user interacts, and/or other activities the user performs on the electronic messaging system 102.

Further, in step 510, the promotional messaging system 104 determines a predicted behavior of the user based on the user's activity patterns. To illustrate by example, the promotional messaging system 104 creates a list of each time the user logs in (or becomes active) to the electronic messaging system 102. After collecting and storing login data, the promotional messaging system 104 can determine that the user logs in (or becomes active) at around the same time each morning, each afternoon, and each evening. As such, the promotional messaging system 104 can determine or predict that the user will become active around these times each day.

In some embodiments, the promotional messaging system 104 determines a predicted behavior for different time periods and/or intervals. For example, the promotional messaging system 104 determines a predicted behavior for each day of the week. For instance, the promotional messaging system 104 determines one predicted behavior of weekdays, and another predicted behavior for weekends and holidays.

As another example, the promotional messaging system 104 determines the predicted behavior based on the user communicating with a particular co-user. Specifically, the promotional messaging system 104 determines that each time a particular co-user sends the user a message, the user quickly response, thereby causes the user to become active on the electronic messaging system 102. Likewise, the promotional messaging system 104 can determine that when other co-users send the user a message, the user is slow to respond, and as a result, does not become active on the electronic messaging system 102.

In an additional example, the promotional messaging system 104 analyzes the user's activity patterns and determines that the user sends a message to (or receives a message from) a particular co-user around the same time each week (e.g., a reminder message). For instance, the user sends a wake-up message to a spouse or receives a lunch message from a co-worker. Accordingly, the promotional messaging system 104 notes this predicted behavior.

In step 512, the promotional messaging system 104 identifies a delivery time based on the predicted behavior. For example, based on determining that the user becomes active at 8:30 AM each weekday morning, the promotional messaging system 104 identifies 8:30 AM as a delivery time. The promotional messaging system 104 can identify a delivery time based on one or more other predicted behaviors described herein.

In some embodiments, the delivery time is based on the time zone where the user is located. For example, many users view messages from other users upon waking up or after getting home from work. Accordingly, the promotional messaging system 104 uses the time zone where the user is located to select a delivery time before the user wakes up (e.g., before 5:30 AM local time).

In step 514, the promotional messaging system 104 delivers the promotional message to the client device 108n of the user near the delivery time. For example, if the delivery time is when the user will next become active on the electronic messaging system 102, the promotional messaging system 104 delivers the promotional message just before the user becoming active, such that the promotional message appears as an unread message when the user views his or her message threads. As another example, if the delivery time is when the user is conversing with a particular co-users, the promotional messaging system 104 can deliver the promotional message to the user after the particular co-user sends one or more messages and before the user reads those messages. In this manner, when the user views his or her message threads to view the messages from the particular co-user, the user sees the promotional message as an unread message.

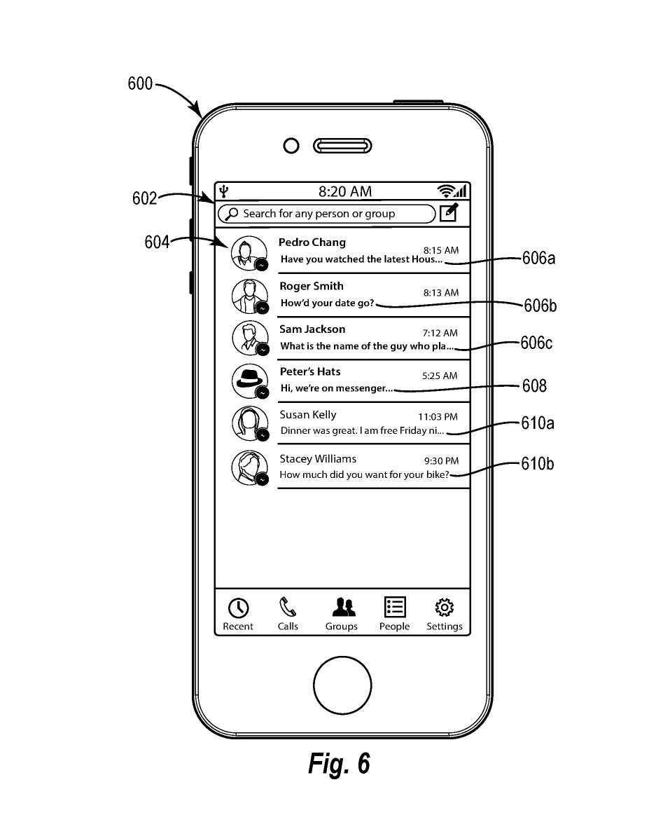

To further illustrate, FIG. 6 shows an example graphical user interface 602 a list of communication threads 604 for a user including a promotional communication thread with a merchant. In particular, the graphical user interface 602 shown in FIG. 6 is displayed on a client device 600. A messaging application running on the client device 600 may display the graphical user interface 602. The client device 600 can be the same or similar to the client devices 108a-n described with respect to FIG. 1.

As shown, the graphical user interface 602 displays the list of communication threads 604. For example, the list of communication threads 604 is displayed as part of a user's inbox within the messaging application running on the user's client device 600. As described above, each communication thread in the list of communication threads 604 corresponds to a conversation between the user and one or more co-users of an electronic messaging system. Accordingly, each communication thread in the list of communication threads 604 includes one or more messages.

In the graphical user interface 602, each communication thread shows a preview of the latest message 606a-610b sent or received in the respective communication thread. In particular, the first three communication threads show unread messages 606a-c (indicated by the bold text). The fourth communication thread shows a preview of the promotional message 608, which is also unread. The last two communication threads show read messages 610a-b.

In particular, the user interface 602 illustrates that the promotional messaging system sent the promotional message 608 on behalf of Peter's Hats at 5:25 AM. In other words, the promotional messaging system determined a delivery time around 5:30 AM and delivered the message such that the user would view the promotional message 608 upon reading his or her unread messages in the morning.

In some embodiments, the promotional messaging system determines a delivery time such that a promotional message is not listed as the first or only message the user views upon viewing his or her communication threads. For example, the promotional messaging system determines that a number of users will likely send messages to the user before the user becomes active on the electronic messaging system. Accordingly, the promotional messaging system determines a delivery time that is before other users typically send messages to the user. Thus, as shown in the graphical user interface 602, the promotional messaging system delivers the promotional message before three other users also sent messages to the user.

In alternative embodiments, the promotional messaging system predates the timestamp of a promotional message. For example, the promotional messaging system detects that one or more users have sent messages to the user, but that the user has yet to read the messages. Accordingly, the promotional messaging system sends the promotional message 608 to the user with a date and time that is before one or more of the unread messages such that the promotional message appears as being delivered before the other unread messages. In this manner, the promotional message 608 is non-intrusively displayed to the user when the user is viewing other unread messages from other users.

In some embodiments, the promotional messaging system displays the promotional message in a predetermined communication thread position within the list of communication threads irrespective of when the promotional message is delivered. For example, the promotional messaging system causes the promotional message to be shown as the third communication thread until the user reads (or otherwise engages, such as hides, blocks, deletes, etc.) the promotional message. Even as communication threads from other users are delivered, the promotional message remains as the third communication thread of the list of communication threads until the user engages with the promotional message. In some cases, the promotional messaging system periodically updates the delivery time of the promotional message to remain in the predetermined position. In other cases, the promotional messaging system hides the delivery time until the user engages with the message.

Upon the user engaging with the promotional message, the promotional message acts as a normal communication thread. For example, the promotional message moves down in communication thread position as the list of communication threads update. Alternatively, upon the user engaging with the promotional message, the promotional message can relocate to its proper chronological position within the communication thread.

In some embodiments, the promotional messaging system conditions sending a promotional message based on one or more rules. For example, one rule specifies not sending a duplicate promotional message. Another rule specifies not sending a promotional message from the same merchant within a threshold time period (described above). An additional rule may include not sending a promotional message to a user if the user has multiple promotional messages (read and/or unread) in his or her inbox. Other rules can include timing restrictions (e.g., not sending a promotional message in the middle of the night when it could wake the user), priority restrictions, and/or frequency restrictions.

In additional embodiments, the promotional messaging system delivers a promotional message to a particular type of client device or when the user is at a particular location. For example, if the user has a smartphone and a tablet, the promotional messaging system 104 specifies delivery to the smartphone only. Also, the promotional messaging system 104 can delay sending a promotional message until a user is at a particular location (e.g., determined using GPS, cellular data, Wi-Fi location data, etc.).

As mentioned above, the promotional messaging system delivers a promotional message to a user via an electronic messaging system. In one or more embodiments, the promotional messaging system and/or electronic messaging system employs update queues to deliver electronic messages to a user. The following briefly discloses various methods of how the promotional messaging system and/or electronic messaging system can deliver an electronic message to a user using update queues. Additional information regarding update queues and sending messages is disclosed in U.S. patent application Ser. No. 16/621,875, “TECHNIQUES FOR INTELLIGENT MESSAGING FOR MESSAGE SYNCING,” which is incorporated herein by reference in its entirety.

As an overview of update queues, the electronic messaging system (i.e., messaging server) may associate a sender update queue and a recipient update queue with a user. Users send messages to their sender update queue. For example, a user's client device uses a Send API to provide a message (or another type of update) to a user's sender update queue. Users receive messages from their recipient update queue. For instance, the user's client device(s) uses a Receive API to retrieve messages from the user's recipient update queue. Further, a user's sender update queue can communicate with another user's recipient update queue. In some embodiments, a user's sender update queue communicates with their own recipient update queue.

For example, a user (e.g., Jane) sends a message within a communication thread to another user (e.g., Peter). In particular, Jane's client device sends the message to her sender update queue. Upon receiving the message, Jane's sender update queue adds the message to the queue as an incoming update for processing. Jane's sender update queue processes the incoming update and transfers the message to Peter's recipient update queue. In some embodiments, Jane's sender update queue also sends the incoming update to Jane's recipient update queue so that she has a copy of the message within her communication thread.

Upon receiving the message, Peter's recipient update queue (and in some embodiments, Jane's recipient update queue) adds the incoming update (e.g., the message) to the queue for processing. In processing the incoming update, Peter's recipient update queue sends the message to Peter. In particular, Peter's recipient update queue pushes the incoming update to each of his client devices. As such, when Peter next accesses the electronic messaging system, each of his client device(s) displays the message to him in the communication thread with Jane. Similarly, Jane's client device can display the message on her client device showing that she sent the message to Peter.

In one or more embodiments, the client devices associated with a user send additional data (also in the form of updates) to the update queues. For instance, continuing the example above, the electronic messaging system sends a delivery confirmation and/or read-receipt to Jane. Specifically, when Peter reads the message from Jane, Peter's client device sends a read-receipt to his sender update queue, which gets passed to Jane's recipient update queue and pushed to Jane's client devices showing that Peter read the message. Likewise, when a user deletes a message on one client device, the electronic messaging system can use the update queues (e.g., send a delta-delete update message through the sender update queue and recipient update queue) to delete the message on the user's other client devices.

When the promotional messaging system sends a promotional message, in one or more embodiments, the promotional messaging system sends the promotional message directly to a user's recipient update queue. For example, the promotional messaging system 104 provides the promotional message directly to the user's update queue, which pushes the message to the user's client device. Alternatively, the promotional messaging system can use a Send API and sender update queue to send promotional messages to users, as described above.

In some embodiments, the promotional messaging system receives incoming updates (e.g., new messages and/or message modifications) with respect to a user directly from the electronic messaging system. Alternatively, the promotional messaging system can receive incoming updates (e.g., new messages and/or message modifications) via a recipient update queue associated with the promotional messaging system. In other words, the electronic messaging system provides incoming updates to the promotional messaging system's recipient update queue, which then passes the update to the promotional messaging system. In this manner, the promotional messaging system receives updates associated with promotional messages, such as if the user has seen, engaged with, and/or read a promotional message. Further, depending on the update, the promotional messaging system can forward the update to the merchant with which the promotional message is associated.

In processing updates (e.g., incoming updates or existing updates not yet processed) in a recipient update queue, a pointer can be associated with a user's client device. The pointer indicates the update last received by the client device. As an example, the recipient update queue has five processed updates A-E and three unprocessed updates F-H for a client device. Accordingly, the pointer indicates that update E is the last processed update for the client device. When the queue successfully sends the new updates (e.g., F-H) to the client device, the pointer is advanced within the queue to update H, indicating that all updates up to and including update H have been pushed to the client device.

In some embodiments, the user has multiple client devices (and/or longer-term storage hosted by the electronic messaging system). In these cases, the electronic messaging system maintains a separate pointer with each client device. As such, the recipient update queue advances each pointer separately as the recipient update queue sends updates to the respective client device (or storage). Thus, when one device is offline, the corresponding pointer stays in place for that device within the recipient update queue. Meanwhile, the recipient update queue continues to send updates to and advance the pointers for the other non-offline devices.

In some embodiments, each update in an update queue (recipient update queue or sender update queue) includes a label, such as a sequence number. Sequence numbers can be based on the order an incoming update is received. In this manner, the same incoming updates in one user's queue can have different sequence numbers from another user's queue. Further, an update queue may be a fixed-size queue or queue with a defined maximum size. It will be appreciated that a defined fixed size or maximum size may be globally defined for all update queues or may be individually defined for different update queues. For instance, the electronic messaging system may allocate larger update queues to users with a higher throughput of updates, such as may correspond to more frequent use of the electronic messaging system. The electronic messaging system may automatically adjust the maximum or fixed size of an update queue for a user to ensure delivery of all updates in a queue.

In one or more embodiments, the recipient update queue (or sender update queue) processes updates in a strict linear order with a monotonically and incrementally based on an update's sequence numbers. For example, the recipient update queue is a first-in-first-out (FIFO) queue in which no update is removed from the queue before any update that was received before it. Alternatively, the recipient update queue organizes and processes updates using other techniques, such as according to update priority (e.g., promotional messages before messages between users), update size, etc.

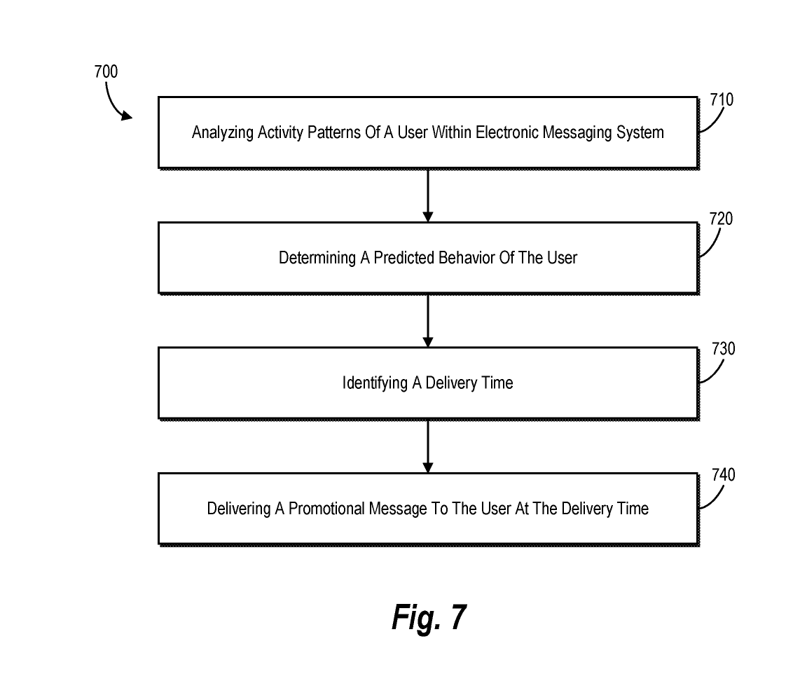

FIG. 7 illustrates a flowchart of a method 700 for delivering a promotional message 608 to a user at a delivery time based on predicted behavior. In one or more embodiments, the promotional messaging system 104 described herein performs the method 700. For example, a promotional messaging system 104 within an electronic messaging system 102, and operating on the one or more server devices 101, performs the method 700. Alternatively, one or more client devices can perform the method 700.

The method 700 includes an act 710 of analyzing activity patterns of a user within an electronic messaging system 102. In particular, the act 710 may involve analyzing, for a user, activity patterns based on past interactions of the user within an electronic messaging system 102. In one or more embodiments, the act 710 includes monitoring the user's activity with respect to sending and receiving messages, logging on or becoming active, etc. In some embodiments, the method also includes the act of receiving a request, from the page owner, to deliver the promotional message 608 to the user via the electronic messaging system 102.

The method 700 also includes an act 720 of determining a predicted behavior of the user. In particular, the act 720 involves determining, based on the analysis of the activity patterns, a predicted behavior of the user with respect to the electronic messaging system 102. In one or more embodiments, the predicted behavior includes the user becoming active or logging on to the electronic messaging system 102. In some embodiments, the predicted behavior includes the user sending electronic messages using the electronic messaging system 102.

In addition, the method 700 includes an act 730 of identifying a delivery time. In particular, the act 730 involves identifying a delivery time associated with the predicted behavior. In one or more embodiments, the act 730 includes identifying that the user has one or more unread messages from active communication threads between the user and other users and identifying the delivery time as being after delivery of the one or more unread messages in the active communication threads and before the user reads the one or more unread messages. In some embodiments, the act 730 involves identifying a time zone where the user resides and identifying the delivery time as being just prior to a time when a majority of users in the time zone becomes active on the electronic messaging system 102.

The method 700 also includes an act 740 of delivering a promotional message 608 to the user at the delivery time. In particular, the act 740 involves delivering, at the identified delivery time, a promotional message 608 to the user via the electronic messaging system 102. In one or more embodiments, delivering the promotional message 608 includes pushing the promotional message 608 to a client device associated with the user. In some embodiments, delivering the promotional message 608 includes delivering the promotional message 608 to a communication thread of the user such that the user is unaware of when the promotional message 608 is delivered.

The method 700 can also include one or more additional acts. For example, the method 700 includes the act of preventing or delaying delivery of the promotional message 608. For instance, the method 700 includes the act of delaying delivery of the promotional message 608 to the user until the user has a threshold number of pending unread communication threads from non-commercial entities, until the user has received a threshold number of messages via the electronic messaging system 102, until the user has received a threshold number of messages via the electronic messaging system 102, and/or for a threshold period if prior electronic messaging communications between the user and a page owner have been negative. Also, the method 700 includes the act of preventing delivery of the promotional message 608 to the user if the promotional message 608 has been previously sent to the user via the electronic messaging system 102 or if promotional messages 608 from the page owner have been previously sent to the user within a period of time.

As mentioned above, FIGS. 8-11 relate to hiding and revealing promotional messages from the merchant. In particular, FIG. 8 illustrates a sequence diagram for determining when to reveal a user's information to a merchant. As shown, FIG. 8 includes the electronic messaging system 102, the promotional messaging system 104, the merchant system 106, and the client device 108n, which are described above. For example, the electronic messaging system 102, the promotional messaging system 104, the merchant system 106, and the client device 108n can be the same or similar to those described with respect to FIG. 1.

In step 802, the merchant, via the merchant system 106, requests delivery of a promotional message to a user via electronic message. For example, the merchant, via the merchant system 106, requests that the promotional messaging system 104 send one or more promotional messages, on behalf of the merchant, to one or more users via the electronic messaging system 102. As mentioned above, the merchant generally provides the request as part of creating a promotional campaign to deliver promotional messages to users in a customized audience, as described above. For purposes of explication, FIG. 8 is described with reference to a single user; however, one will appreciate that the concepts and methods described can be expanded to multiple users.

In response, the promotional messaging system 104 delivers the promotional message to the client device 108n associated with the user, as step 804 illustrates. As described above, the user can be part of a customized audience, and the promotional messaging system 104 can deliver the message to the user at an identified delivery time. Alternatively, in some embodiments, the promotional messaging system 104 can deliver the promotional message to any user of the electronic messaging system 102 and/or deliver the promotional message to the user at any time.

In step 806, the client device 108n displays the promotional message to the user. For example, the client device 108n displays the promotional message within an inbox of a messaging application running on the client device 108n. In addition, the promotional message can be displayed as part of a communication thread, as described above. For instance, the client device 108n displays a preview of the promotional message within a communication thread between the user and the merchant, and the client device 108n can mark the communication unread until the user reads the promotional message (or otherwise engages with the message).

Upon delivering the promotional message to the client device 108n, the promotional messaging system 104 monitors the user's activity with the electronic messaging system 102, as shown in step 808. In particular, the promotional messaging system 104 can monitor whether the user has become active since the delivery of the promotional message, viewed the promotional message, viewed other messages, responded to the promotional message, responded to other messages, and/or otherwise engaged with the promotional message (e.g., hid, blocked, deleted, archived, marked as read, began composing a response but did not send the response, etc.) In some embodiments, the client device 108n also assists in monitoring the user's activity with the user's activity with the promotional message and other messages within the electronic messaging system 102.

While monitoring the user's activity with the promotional message, the user will either respond or not respond to the promotional message. Thus, as shown in FIG. 8, steps 810-816 correspond to Option A where the user responds to the promotional message. Steps 818-820 correspond to Option B where the user does not respond to the promotional message. Each option will be described in order below.

In step 810, while monitoring the user's activity, the client device 108n detects a response to the promotional message. Generally, a response corresponds to a user sending a message back to the merchant in the communication thread where the promotional message is located. In some embodiments; however, a response corresponds to a user opening and/or viewing the promotional message. Irrespective of the type of response being monitored, the client device 108n can detect the response to the promotional message and provide an indication to the promotional messaging system 104 of the user's response, as step 812 shows.

In some embodiments, detecting a response to the promotional message includes using natural language processing to determine that the user is indeed responding to the promotional message. For example, if after receiving the promotional message, the user sends a message that states, “My package was missing an item,” the promotional messaging system 104 can determine that the message is not in response to the promotional message. Later if the user responds to the promotional message (e.g., asks, “Is that sale on jeans still going on” after a promotional message about jeans is sent), the promotional messaging system 104 detects that the user responded to the promotional message. Similarly, if a communication thread includes multiple promotional messages from the merchant, the promotional messaging system 104 can identify to which promotional message the user response corresponds, in any.

In some embodiments, and as described in additional detail below with respect to FIG. 9B, the user is informed that the merchant will not be provided with information about the user unless the user responds to the promotional message. Accordingly, when the client device 108n indicates to the promotional messaging system 104 that the user has responded to the promotional message, the client device 108n is providing the indication with the user's consent.

In step 814, the promotional messaging system 104 reveals the promotional message to the merchant based on the user responding to the promotional message. In other words, the promotional messaging system 104 indicates to the merchant that the promotional message has been sent to the user by the promotional messaging system 104 on the merchant's behalf (e.g., as part of a promotional campaign) and that the user has responded to the promotional message.

By waiting to reveal the promotional message from the merchant until the user response to the promotional message, the promotional messaging system 104 protects the privacy of the user. For example, if the merchant is participating in multiple promotional campaigns, the promotional messaging system 104 includes the response from the user, but not the targeted campaign that targeted the user. Thus, the merchant cannot directly attribute characteristics from a particular promotional campaign to the user. In some cases, the merchant infers additional information about the user based on information stored by the merchant; however, this information is not directly provided by the promotional messaging system 104.

In some embodiments, revealing the promotional message to the merchant includes updating the communication thread between the merchant and the user to show that the promotional message was sent to the user, and/or when the promotional message was delivered. Thus, before the promotional messaging system 104 reveals the promotional message to the merchant, the merchant's communication thread does not reflect that the promotional message has been sent to the user, even though the promotional message appears in the user's communication thread on the client device 108n. In other words, the communication thread on the merchant system 106 is separate from the communication thread belonging to the user on the client device 108n, even though both communication threads are between the user and the merchant.

In step 816, the promotional messaging system 104 provides the user's response to the merchant. In particular, the promotional messaging system 104 adds the user's response to the merchant's communication thread after the promotional message. In this manner, the merchant receives the response in its proper context, as a response to the promotional message, which enables the merchant to reply quickly to the user, if needed.

As shown in Option B (steps 818-820), the promotional messaging system 104 and/or client device 108n monitors the user's activity with the promotional message; however, the user does not engage with the promotional message. For example, the client device 108n monitors the user's activity for a period to determine whether the user will respond to the promotional message.

The period can correspond to a variety of intervals. For example, the period is time-based, such as one or more hours, days, weeks, months, etc. In this example, the client device 108n monitors the user's activity with the promotional message for the requisite time, and if the user does not respond to the promotional message, the client device 108n indicates such to the promotional messaging system 104, as illustrated in step 818.

In another example, the period is message-based. For instance, the period is x number of messages sent by and/or received (e.g., read) by the user from the time the promotional messaging system 104 delivers the promotional message. Thus, if the user reads the required number of messages without responding to the promotional message, then the client device 108n indicates to the promotional messaging system 104 that the user has failed to respond to the promotional message in a timely manner. In some cases, rather than messages, the period corresponds to a set number of communication threads updating since delivery of the promotional message.

As another example, the period is activity-based. To illustrate, the period is y number of times the user logs in or become active. Thus, if the user logs in y times without responding to the promotional message, the client device 108n provides the above-referenced indication to the promotional messaging system 104.

The period, in still another example, is offer-based. For instance, the promotional message includes an offer that is time-sensitive (e.g., the offer expires). Additionally, and/or alternatively, the offer may have a limited number of redemptions available. Thus, when the available redemptions run out, the period ends. Again, if the user fails to respond to the promotional message before the offer terminates or becomes used up, the client device 108n indicates a non-response to the promotional messaging system 104. Further, in some embodiments, the period is determined based on a combination of multiple factors described above.

In step 820, the promotional messaging system 104 provides no response to the merchant. In other words, because the user did not respond to the promotional message, the promotional messaging system 104 does not reveal to the merchant that the promotional messaging system 104 delivered the promotional message to the user. Thus, while the user's communication thread between the user and the merchant shows the promotional message, the merchant's corresponding communication thread does not show the promotional message. In this manner, the user's privacy is protected.

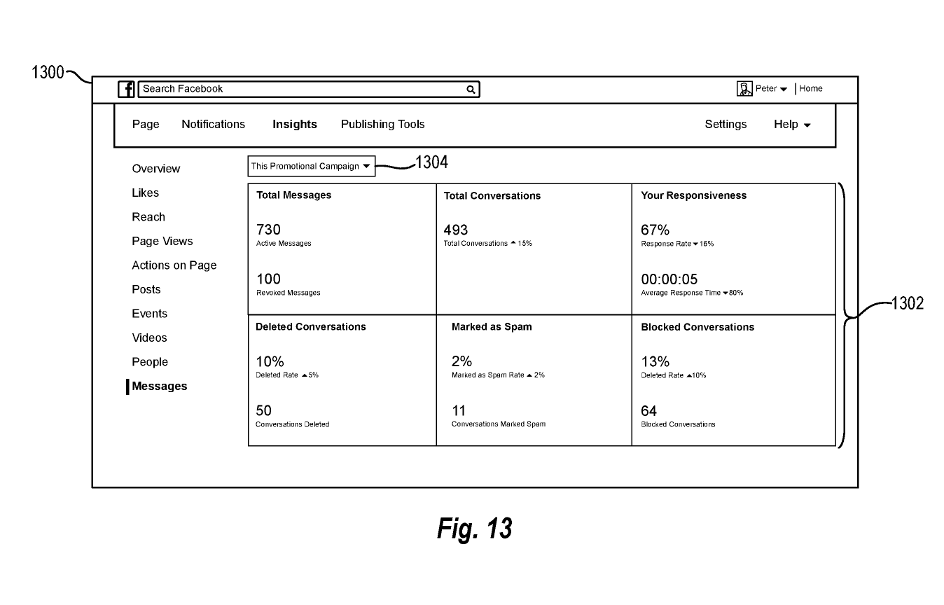

In one or more embodiments, and as described below in connection with FIG. 13, the promotional messaging system 104 provides merchant insights to the merchant. In general, merchant insights provide overall statistics about a promotional campaign and/or users in a customized audience. Thus, the merchant still receives helpful information about the type of users and/or the number of users that did not respond to the promotional message, but without the promotional messaging system 104 revealing personal information of the users themselves.

As mentioned above, the promotional messaging system 104 and/or electronic messaging system 102 employs update queues (e.g., a sender update queue and a recipient update queue) to send messages and/or updates to users of the electronic messaging system 102. The following provides a description regarding the electronic messaging system 102, the promotional messaging system 104, or both using update queues to hide and reveal messages from a merchant.

To illustrate, the promotional messaging system 104 sends a promotional message to a user. In particular and as described above, the promotional messaging system 104 sends the promotional message in an update to the user's recipient update queue, which forwards the message to the user's client device 108n. However, the promotional messaging system 104 does not send the message to the merchant's recipient update queue.

When the user responds or otherwise engages with the message, the client device 108n, via the user's sender update queue, notifies the promotional messaging system 104 of such. As that point, the promotional messaging system 104 sends the promotional message to the recipient update queue of the merchant, which then delivers the message to the merchant. If the user responds to the message, the electronic messaging system 102 can either send the message to the merchant directly or via the promotional messaging system 104 using the update queues, as discussed above.

In some embodiments, the promotional messaging system 104 tags a promotional message sent to a user. A tag can identify a user. Further, a tag can identify a specific promotional message, a promotional campaign, a merchant, etc. In some embodiments, tags within a promotional message can be transferred to a user's message when the user replies to the promotional message. For example, the promotional messaging system 104 receives a response message from a user that includes a number of tags. The promotional messaging system 104 uses the tags to identify the user, the merchant, the specific promotional message to which the user is responding, and the associated promotional campaign.

In one or more embodiments, the promotional messaging system 104 uses tags in place of storing promotional messages. For example, a promotional messaging system 104 sends a promotional message to a user with a tag indicating the specific promotional message and/or that the promotional message should be copied back to the merchant upon the user responding. In this example, the promotional messaging system 104 does not store a copy of the specific promotional message send to the user (or other users). Rather, when a user responds, the promotional messaging system 104 identifies the tag, looks up the specific promotional message in a database, and sends a copy of the promotional message (or contextual information identifying the promotional message) to the merchant. In this manner, the promotional messaging system 104 can track and manage large volumes of messages across multiple campaigns without maintaining a copy of every promotional message sent in every campaign.

Also, the promotional messaging system 104 can use tags to provide statistical information to a merchant regarding one or more promotional campaigns. For example, the promotional messaging system 104 determines merchant insights (shown in FIG. 13 below) based on tracking tags associated with promotional messages. Further, the promotional messaging system 104 can enable a merchant to search users, promotional messages, and/or campaigns based on tags. For instance, a merchant searches for all messages that have a specific tag or keyword within a tag.

FIGS. 9A-9D illustrate example graphical user interfaces of a user engaging with a promotional message within an electronic messaging system. In particular, the graphical user interfaces 902a-b shown in FIGS. 9A-9D are displayed on a client device 900. The client device 900 may display the graphical user interfaces 902a-b as part of a messaging application running on the client device 900. The client device 900 can be the same or similar to the client devices 108a-n described with respect to FIG. 1.

The graphical user interface 902a in FIG. 9A includes many of the same elements described above in connection with the graphical user interface illustrated in FIG. 6. For example, the graphical user interface 902a displays a list of communication threads 904 organized in chronological order. Further, as shown, a number of the communication threads include unread messages (indicated by the bold text), while other communication threads include read messages.

In addition, the graphical user interface 902a includes a notification 906 regarding a promotional message from a merchant (i.e., Peter's Hats). As shown, the graphical user interface 902a displays the notification 906 above the list of communication threads 904. Thus, when the user of the client device 900 opens the messaging application, he or she sees the notification 906. As such, the user can choose to view or ignore (e.g., hide, delete, block, etc.) the promotional message.

To display the notification 906, the promotional messaging system 104 delivers the promotional message to the user's client device 900. For instance, the user is selected as part of a customized audience and/or part of a targeted promotional campaign as described above. Upon delivering the promotional message, rather than displaying the promotional message in a communication thread, as described previously, the promotional messaging system instructs the messaging application to instead provide the notification 906 and allow a user to choose to view the promotional message.

Upon the user selecting to view the promotional message via the notification 906, the graphical user interface 902a updates to present the communication thread that includes the promotional message 914. To illustrate, FIG. 9B shows the updated graphical user interface 902b, which includes a communication thread 910. The communication thread 910 includes a communication thread header 908 and a promotional message 912. The header 908 indicates that the communication thread is between the user and Peter's Hats (i.e., the merchant or page owner). The header 908 also includes other tools and information available to the user.

The communication thread 910 includes messages between the user and Peter's Hats, including previous communications. In particular, the communication thread 910 includes a promotional message 912 from Peter's Hats. As shown, the promotional message 912 includes a recommendation for a product (i.e., summer shades) based on the user's previous purchase (i.e., a baseball cap). Further, the promotional message 912 provides an image of the recommended product and a link 916 to additional products.

The updated graphical user interface 902b also shows a privacy warning 914 to the user. The privacy warning 914 indicates that the merchant will not be informed regarding the promotional message 912 unless the user grants authorization. In particular, the promotional messaging system provides the privacy warning 914 to inform the user that even though the user is viewing the promotional message 912, the promotional messaging system will not notify the merchant about the promotional message 912 unless the user responds or otherwise interacts with the promotional message 912. In other words, the promotional messaging system hides the fact that the user has received the promotional message 912 from the merchant until the user responds. Thus, the promotional messaging system protects the user's privacy information until the user provides consents.

In one or more embodiments, once the user consents to share his or her information, the merchant can use that information to serve the user better. For instance, upon the user's consent, the promotional messaging system links the user with the targeted campaign that includes the user. The merchant, using the additional information about the user, can tailor product recommendations to the user.

In one or more embodiments, the promotional message 912 is associated with a promotional identifier (e.g., promo_id or coupon_id). As mentioned above, the merchant can participate in a promotional campaign that serves promotional messages over various communication media. When a user selects the promotional messages via any of the communication media, the promotional message system can direct the user to the communication thread 910 and present the promotional message 912 to the user within the communication thread 910. In particular, the promotional message system uses the promotional identifier to look up which promotional message the user selected and provides the same promotional message within the communication thread 910.

In a similar manner, if the merchant offers a survey via various communication media, the electronic message system can, upon a user selecting the survey, direct the user to the electronic message system to complete the survey. In particular, when a user selects a survey, the electronic message system can receive a survey id (e.g., survey_id) that identifies the survey, and in some cases, a promised offer in connection with the user completing the survey. The electronic message system then provides the survey within the communication thread 910, for example, as a string of messages from the merchant and responses from the user. Upon completion of the survey, the promotional message system can offer a promotional message 912 to the user as a reward.

In some embodiments, when a promotional message is presented on a different communication medium other than the electronic message system, the offered promotion can be conditional upon the user adding the merchant as a contact within the electronic message system 102. By adding the merchant as a contact within the electronic message system, the merchant can provide the promised offer via the promotional message 912 and/or provide future offers via the electronic message system. Further, when the promotional message system presents a promotional message to a user, the user and merchant can directly communicate with each other regarding the offered promotion via the electronic message system.

Additionally, the promotional messaging system enables the user to manage his or her preference with respect to promotional messages from the merchant. As shown, the updated graphical user interface 902b displays a manage option 918. Selecting the manage option 918 causes the updated graphical user interface 902b to display additional preferences with respect to messages from the merchant.

To illustrate, FIG. 9C illustrates these additional preferences 920. For example, the user can select to learn more about promotional messages, block promotional messages, or block all messages from the merchant. In one or more embodiments, the additional preferences 920 include a selection to mute promotional messages for a time period. In some embodiments, the additional preferences 920 include a selection to promote messages from the merchant within the communication threads listing or to provide notifications to the user when promotional messages are received from the merchant.

As shown in FIG. 9D, the user responds to the merchant by sends a reply message 922 to Peter's Hat. In particular, the user inquires about the product offered in the promotional message 912. Alternatively, the user responds to the promotional message 912 by selecting the recommended product or the link 916 provided in the promotional message 912.

As mentioned above, responding to the promotional message 912 provides consent for the promotional messaging system to inform the merchant regarding the promotional message 912. In particular, the promotional messaging system indicates to the merchant, via the merchant system, that the promotional message 912 was sent to the user. Further, in some embodiments, the promotional messaging system provides the contents of the promotional message 912 and the time the promotional message 912 was sent to the merchant. In one or more embodiments, as mentioned above, the promotional messaging system provides additional information about the user to the merchant.

As mentioned above, a merchant can use the electronic message system to communicate with a user. For example, the merchant answers general questions or queries of a user (e.g., a customer or potential customer) or questions related to a specific promotional message. Further, as mentioned above, the electronic message system can direct a user from another communication media (e.g., an Internet website, email, text message, etc.) to a communication thread with the merchant within the electronic message system. Often, a user chooses to move from the other communication medium to the electronic message system because the user wants to communicate directly with the merchant, for example, to ask the merchant a question.

In some embodiments, the electronic message system receives a session identifier (e.g., session_id) when the user switches from another communication medium to the electronic message system. A session identifier can include similar information as the promotional identifier and/or campaign identifier described above. Further, a session identifier can provide additional context regarding the user. For example, a session identifier indicates to the merchant what product the user was viewing (or a product history) prior to requesting contact with the merchant. As another example, the session identifier indicates the step the user was on in a multi-step sequence or process (e.g., the step where the user is at in the check-out process or the question where a user is having trouble with in a survey or assignment). In this manner, electronic message system provides the merchant with an indication regarding the user's context such that the merchant has an understanding of the user's issue and can assist the user without causing the user to repeat or needlessly explain their problem or issue.

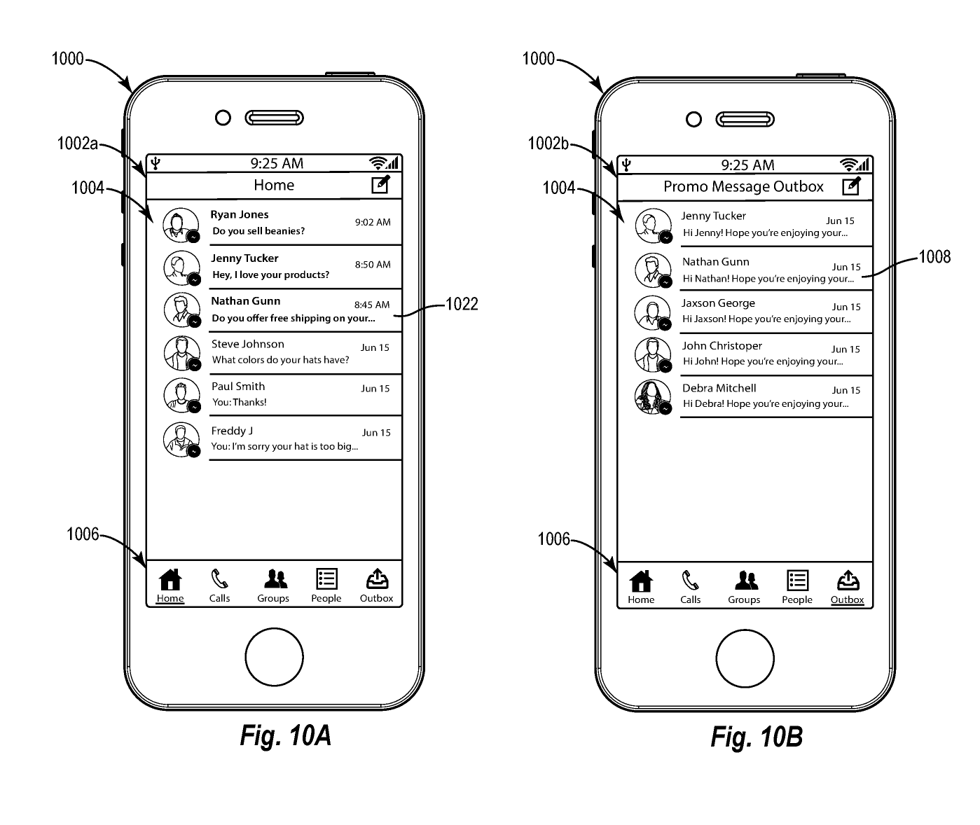

FIGS. 10A-10B illustrate example graphical user interfaces of the same communication threads as seen from the merchant client device 1000. The graphical user interfaces 1002a-b shown in FIGS. 10A-10B are displayed on a merchant client device 1000. The merchant client device 1000 can display the graphical user interfaces 1002a—as part of a messaging application running on the client device 1000. The client device 1000 can be the same or similar to the client devices 108a-n described with respect to FIG. 1. Alternatively, the merchant client device 1000 can be a desktop, workstation, or other type of non-mobile computing device. Thus, while the merchant client device 1000 appears as a mobile device, one will appreciate that one or more administrators for the merchant can use various types of client devices to access the graphical user interfaces 1002a-b.

Specifically, FIG. 10A illustrates a graphical user interface 1002a of the merchant (i.e., Peter's Hats). The graphical user interface 1002a displays a “Home” Screen showing a list of communication threads 1004 between the merchant and customers, including potential customers. Further, the graphical user interface 1002a illustrates a navigation bar at the bottom of the graphical user interface 1002a emphasizing the Home Screen icon.

As shown, the list of communication threads 1004 includes a communication thread from Nathan Gunn, which corresponds to the user described above in FIGS. 9A-D. As such, the communication thread 1022 includes the promotional message 912 and the reply message 922 described above. In addition, because Nathan Gunn replied to the promotional message 912, the merchant can pair the user (i.e., Nathan Gunn) with the exact message was sent to him and/or other information about the user. Further, the merchant knows that the user is interested in furthering communications with the merchant and/or receiving additional information about the product in the promotional message 912.

While the reply message 922 is shown in the communication threads 1004 of the merchant of FIG. 10A, one will appreciate that the promotional messaging system hides that the promotional message 912 was sent to the user until the user grants the promotional messaging system authorization to disclose such. Thus, if the merchant has a previous communication thread with the user from before the promotional message was sent out, the merchant's communication thread does not include the promotional message. However, when the user responds or otherwise grants authorization, the promotional messaging system updates the merchant's communication thread to reveal that the promotional message has been sent to the user.

In some embodiments, the promotional messaging system provides an outbox to a merchant to assist the merchant in managing promotional campaigns. For example, FIG. 10B illustrates a graphical user interface 1002b of an Outbox Screen. For instance, the navigational bar 1006 in the graphical user interface 1002b emphasizes the Outbox icon.

As shown in FIG. 10B, the graphical user interface 1002b shows that a number of promotional messages have been sent to users. The promotional messages may be part of the same promotional campaign or different campaigns. Similar to the Home Screen, the Outbox Screen only shows when a user responds to a received promotional message or otherwise grants permission. Thus, for each of the displayed promotional messages, each of the users authorized that the promotional messaging system to inform the merchant regarding each user receiving a promotional message.

The promotional messaging system 104 can employ similar techniques of not revealing a promotional message until a user responds to the promotional message (also referred to as a one-way send/message) in other contexts. For example, the promotional messaging system 104 recognizes that a user visits the webpage of a merchant (e.g., using a tracking pixel). In response, the promotional messaging system 104 messages the user on behalf of the merchant. In this case, the promotional message is a message that facilitates communication with the user and not necessarily providing a specific product or service offer to the user. For instance, the message inquires if the user would like more information about products the user viewed. If the user responds, the promotional messaging system 104 forwards the sent message (or some other indication of context) and the response to the merchant 104. Otherwise, if the user does not respond, the promotional messaging system 104 does not send the promotional message to the merchant; thus, the merchant remains unaware that the user visited their website or received a message. Thus, the promotional messaging system 104 protects the user's privacy through one-way messaging in a variety of contexts.

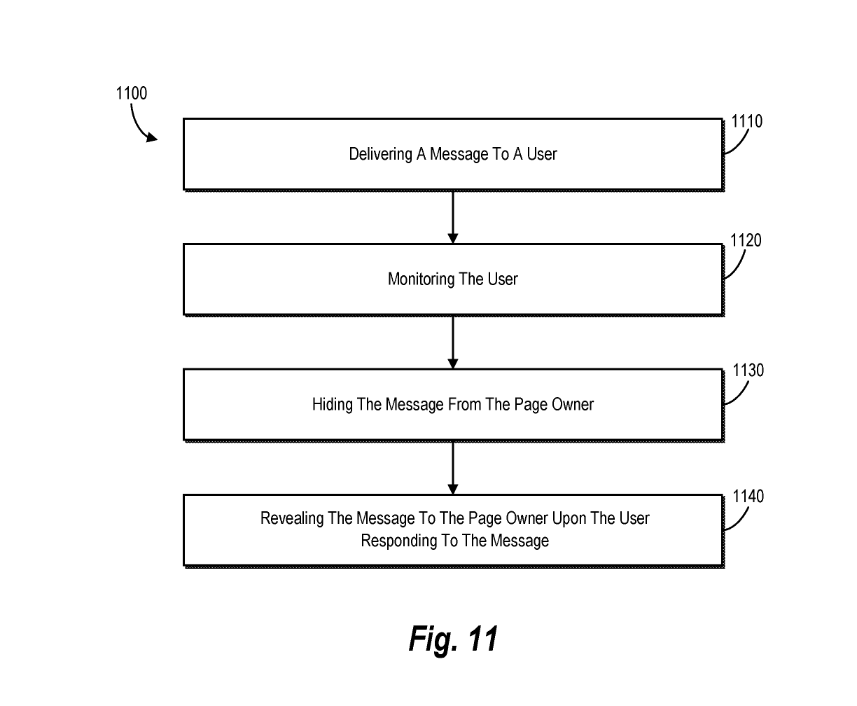

FIG. 11 illustrates a flowchart of a method 1100 for revealing a promotional message 912 to the merchant via the merchant system 106. In one or more embodiments, the promotional messaging system 104 described herein performs the method 1100. For example, a promotional messaging system 104 within an electronic messaging system 102, and operating on the one or more server devices 101, performs the method 1100. Alternatively, one or more client devices can perform the method 1100.

The method 1100 includes an act 1110 of delivering a message to a user. In particular, the act 1110 may involve delivering a promotional message 912 (or another electronic message) on behalf of a page owner 106 to an inbox 904 of a user within an electronic messaging system 102. In one or more embodiments, the act 1110 also includes displaying a notification 906 to the user that the promotional message 912 is from the page owner 106. In some embodiments, the act 1110 also includes indicating 914 to the user, in connection with the promotional message 912, that the page owner 106 will not be made aware that the user has received the promotional message 912 unless the user responds to the promotional message 912.

The method 1100 also includes an act 1120 of monitoring the user. In particular, the act 1120 involves monitoring whether the user responds to the promotional message 912 (or another electronic message). In one or more embodiments, the act 1120 involves determining whether the user selects a link 916 within the promotional message or determining whether the user opens and reads the promotional message. In some embodiments, the act 1120 involves determining that the user declines the promotional message, where the user declines the promotional message by ignoring the promotional message, hiding the promotional message from the inbox of the user, or blocking promotional messages from the page owner.

In addition, the method 1100 includes an act 1130 of hiding the message from the page owner 106. In particular, the act 1130 involves hiding, from the page owner 106, the promotional message 912 (or another electronic message) delivered to the user until the user responds to the promotional message 912 (or another electronic message). In one or more embodiments, the act 1130 includes delivering the promotional message 912 to a temporary database until the user responds to the promotional message or until a period is reached, upon which the promotional message is deleted from the temporary database.

The method 1100 also includes an act 1140 of revealing 1022 the message to the page owner 106 upon the user responding to the message. In particular, the act 1140 involves revealing 1022, upon the user responding 922 to the promotional message 912 (or another electronic message) and within the electronic messaging system 102, the promotional message 912 (or another electronic message) to the page owner 106. In one or more embodiments, revealing 1022 includes moving the promotional message into a communication thread 910 between the user and the page owner 106.

The method 1100 can also include one or more additional acts. For example, the method 1100 includes the act of delivering, upon the user responding to the promotional message 912 (or another electronic message), the response from the user to the page owner 106 in connection with revealing 1022 the promotional message 912 to the page owner 106. In addition, the method 1100 can include the act of providing a report 1300 of insights 1302 to the page owner 106 indicating a number of users that have responded to the promotional message 922 and a number of users that have not responded to the promotional message. Further, the method 1100 may include the act of receiving, from the page owner 106, demographic criteria or user parameters 314a-b specifying a target audience to which the user belongs.

As mentioned previously, FIGS. 12-14 relate to the promotional messaging system revoking a promotional message sent to a user. In particular, FIG. 12 illustrates a sequence diagram for revoking a promotional message. As shown, FIG. 12 includes the electronic messaging system 102, the promotional messaging system 104, the merchant system 106, and the client device 108n, as described above. For example, the electronic messaging system 102, the promotional messaging system 104, the merchant system 106, and the client device 108n can be the same or similar to those described with respect to FIG. 1.

As step 1202 illustrates, the merchant, via the merchant system 106, requests delivery of a promotional message a user via electronic message. For example, the merchant requests that the promotional messaging system 104 send one or more promotional messages, on behalf of the merchant, to one or more users via the electronic messaging system 102. As mentioned above, the merchant generally provides the request as part of creating a promotional campaign to deliver promotional messages to users in a customized audience. For purposes of explication, FIG. 12 is described with reference to a single user; however, one will appreciate that the concepts and methods described can be expanded to multiple users.

In response to the request, the promotional messaging system 104 delivers the promotional message to the client device 108n associated with the user, as step 1204 illustrates. As described above, the promotional messaging system 104 can deliver the message to the user at an identified delivery time. Alternatively, in some embodiments, the promotional messaging system 104 can deliver the promotional message to any user of the electronic messaging system 102 and/or deliver the promotional message to the user at any time.

In step 1206, the client device 108n provides the promotional message to the user's inbox. For example, the client device 108n delivers the promotional message to the inbox of a messaging application running on the client device 108n of the user. For instance, the client device 108n provides the message as part of a communication thread as shown above in FIG. 6 or otherwise notifies the user as shown in FIG. 9A.

After delivering the promotional message, the promotional messaging system 104 monitors the user's activity with respect to the promotional message, as step 1208 shows. For example, the promotional messaging system 104 detects whether the user engages or ignores the promotional message. In particular, the promotional messaging system 104 detects that the user views, reads, marks as read, and/or responds to the promotional message. Alternatively, the promotional messaging system 104 detects that the user hides, blocks, mutes, or deletes (without viewing) the promotional message. In some cases, the promotional messaging system 104 employs the services of the client device 108n to monitor and report on the user's activity with respect to the promotional message.

Based on monitoring the user's activity with respect to the promotional message, the promotional messaging system 104 determines that the user has not read the promotional message for a period, as step 1210 illustrates. For example, even though the promotional message is delivered, the user did not know about the promotional message and the message has become stale (e.g., outdated and/or of no value to the user). For instance, the user did not access the electronic messaging system 102 during the period. In another instance, the user accesses the electronic messaging system 102, but does not see the promotional message or realized that the promotional message was delivered. Regardless of why the user did not read or view the promotional message, the promotional messaging system 104 can detect that the user did not engage with the promotional message.

As described above in connection with FIG. 8, the period can correspond to a variety of intervals. For example, the period can be time-based, such as one or more hours, days, weeks, months, etc. In another example, the period can be message-based. Additionally, the period can be activity-based or offer-based. Further, the period can be based on a combination of the intervals mentioned above.

As mentioned, in some embodiments, the period can be time-based or offer-based. As one example, the promotional messaging system 104 maintains a log of all users that received a promotional message as part of a promotional campaign. The log updates as users respond to the promotional message to indicate which users have responded. When the promotional campaign ends (or a time period passes), the promotional messaging system 104 identifies each user in the log that has not engaged with the promotional message.

In one or more embodiments, the period may be shortened or canceled based on the user interacting negatively with the promotional message. For example, if the user hides, blocks, mutes, or deletes (without viewing) the promotional message, the promotional messaging system 104 detects that the user is not interested in the promotional message and/or messages from the particular merchant, and thus, end the period early.

In step 1212, the promotional messaging system 104 sends a delete message to revoke the promotional message. In particular, the promotional messaging system 104 can send a delta-delete message (described below), or some other type of delete command, to instruct the client device 108n to remove the promotional message. For instance, the promotional messaging system 104 deletes the promotional message for a database of messages stored for the user, and when the user next becomes active, the client device 108n removes (i.e., revokes) the promotional message from the user's inbox, as shown in step 1214.

Revoking the message, in some embodiments, can remove the promotional message from a communication thread between the user and the merchant. For example, upon revoking the message, the communication thread appears as if the message was never delivered. In this manner, promotional messages that the user missed or that are no interest to the user (i.e., ignored by the user) do not clutter the user's inbox. Further, because the promotional messaging system 104 revoked the promotional message, the promotional message is not counted as a view or impression within a promotional campaign.

In additional embodiments, the promotional messaging system 104 revokes a promotional message based on the number of unread promotional messages in a user's inbox. For example, if a user has over a predetermined number (e.g., three) of unread promotional messages, the revokes the oldest promotional message before sending a new promotional message. In this manner, the promotional messaging system 104 prevents a user's inbox from filling up with promotional messages unread by the user.

In step 1216, the promotional messaging system 104 optionally sends merchant insights about the promotional campaign to the merchant. As an example of merchant insights is provided in FIG. 13, described below. In general, the merchant insights provide a snapshot of one or more promotional campaign to the merchant. For example, the merchant insights can indicate the number of promotional messages that have been revoked. Further, in some cases, the merchant insights include demographic information of users from whom the promotional messages are being revoked (e.g., when the number of users is above a threshold value). In this manner, the promotional messaging system 104 can help a merchant improve their promotional campaign while maintaining the privacy of users of the electronic messaging system 102.

In step 1218, the promotional messaging system 104 determines a new promotional message to send to the user. In essence, because the previous promotional message was revoked, the user did not receive the promotional message. As such, the promotional messaging system 104 can send a new promotional message to the user without the user knowing.

In some embodiments, the promotional messaging system 104 determines a new promotional message to send to the user. For example, the promotional messaging system 104 updates the offer period for the offer in the previous promotional message and resends the promotional message with the extended offer period. As another example, the promotional messaging system 104 sends a promotional message with a new offer, but from the same merchant. Alternatively, the promotional messaging system 104 sends an offer from a different merchant.

In one or more embodiments, the promotional messaging system 104 does not send the same promotional message to a user. Thus, if the user purposely ignored the message when it was first sent, the user may become annoyed to see a repeat offer. In some embodiments, the promotional messaging system 104 requires a time period to pass (e.g., two days, a week, two weeks, etc.) before sending a promotional message from the same merchant. In this manner, the promotional messaging system 104 limits the exposure that a user receives from the same merchant, which protects the user from becoming annoyed and frustrated with that merchant.

Determining which promotional message to send, in some embodiments, is based on why the previous promotional message is revoked. For example, if the previous promotional message is revoked because the user did not log on or have a chance to view the promotional message, then the promotional messaging system 104 can resend the same promotional message. If the user likely saw that the promotional message was delivered, but purposefully ignored the message (e.g., the promotional messaging system 104 detected the user viewing and/or responding to communication threads before and after the promotional message) or blocked/hid/deleted the promotional message, then the promotional messaging system 104 determines not to reserve the same promotional message. Further, the promotional messaging system 104 may determine to pause messages send on behalf of the merchant for the threshold time period.

Upon determining the new promotional message to send to the user, the promotional messaging system 104 delivers the new promotional message to the user, as shown in step 1220. In particular, the promotional messaging system 104 delivers the new promotional message to the client device 108n, as described above. As with the previous promotional message, the new promotional message can be revoked if the user again ignores or otherwise does not engage with the new promotional message.

In some embodiments, the promotional messaging system 104 revokes a promotional message in order to replace it with an updated promotional message. For example, the promotional messaging system 104 delivers a promotional message to a user. While monitoring the user's activity with respect to the promotional message, the promotional messaging system 104 receives an updated promotional message (e.g., fixing a typo in the promotional message, providing updated information, etc.) For each user in the promotional campaign that has not viewed the promotional message, the promotional messaging system 104 can revoke the promotional message and replace it with the updated message. Then, when a user views the promotional message, the user will only read the updated promotional message, without knowing about the outdated promotional message.

As mentioned above, the promotional messaging system can provide merchant insights to a merchant. In particular, FIG. 13 illustrates an example graphical user interface 1300 of merchant insights 1302 provided to a merchant. The graphical user interface 1300 can be displayed on a client device, such as the one or more client device(s) 103 described in FIG. 1.

As illustrated, the graphical user interface 1300 provides merchant insights 1302 to the merchant. The promotional messaging system can display merchant insights 1302 particular to a promotional campaign (e.g., “This Promotional Campaign” 1304) or other promotional campaigns. Also, the merchant insights 1032 can be included in the promotional management application described above. In some embodiments, the promotional messaging system provides merchant insights combining data from across promotional campaigns.

The merchant insights 1302, as shown, provide helpful indicators regarding promotional messages sent to a user via an electronic messaging system. For example, the merchant insights 1302 indicate the number of promotional message sent (and revoked), the total number of conversations, and responsiveness indicators. The merchant insights 1302 also indicate the number of messages marked as spam, deleted, and blocked. Further, the merchant insights 1302 provide comparative information, for example, comparing the current promotional campaign against one or more other promotional campaigns. In some embodiments, the merchant insights 1302 provide names or identifiers (e.g., numbers) of the user that have replied to a promotional message. For example, as described above, the promotional messaging system uses tags within messages to track the users have responded to which promotional messages. Accordingly, the merchant can improve current and further promotional campaigns by the promotional messaging system 104 providing merchant insights 1302 to a merchant.

As described above, the promotional messaging system may employ update queues to send and track promotional messages with users. In some embodiments, the promotional messaging system uses update queues to revoke message. For example, if the electronic messaging system or a user's client device notifies the promotional messaging system that a user has not engaged with a promotional message for a period, the promotional messaging system sends a message modification update, such as a delete message command to the user. In particular, the electronic messaging system sends a delta-delete update to the user's recipient update queue that, when processed, instructs the user's client device(s) to delete the promotional message for the communication thread between the user and the merchant. Similarly, if the promotional messaging system is modifying a promotional message (e.g., to fix a type or extend an offer), the promotional messaging system can send the modification in an update to the user's client device(s) via the user's recipient update queue, as described above.

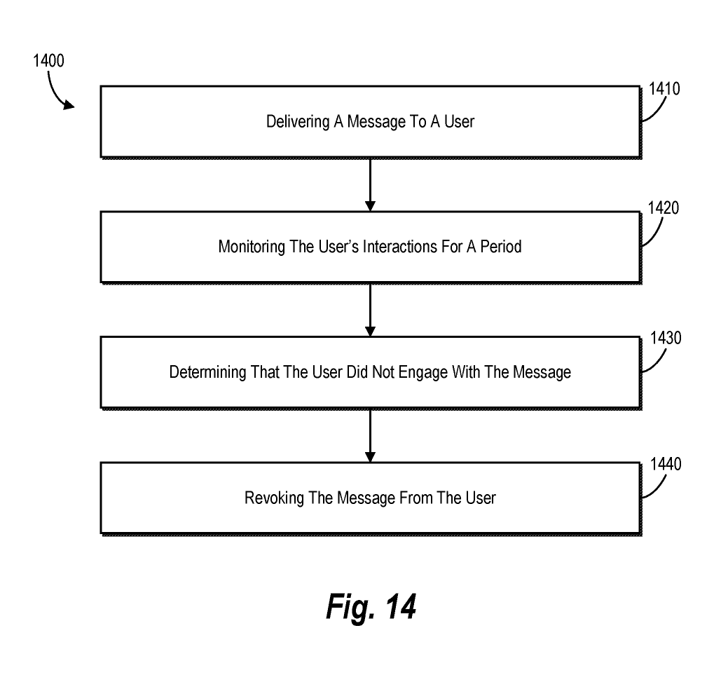

FIG. 14 illustrates a flowchart of a method 1400 for revoking a promotional message 912. In one or more embodiments, the promotional messaging system 104 described herein performs the method 1400. For example, a promotional messaging system 104 within an electronic messaging system 102, and operating on the one or more server devices 101, performs the method 1400. Alternatively, one or more client devices can perform the method 1400.

The method 1400 includes an act 1410 of delivering a message to a user. In particular, the act 1410 may involve delivering a promotional message 912 on behalf of a page owner (i.e., merchant) to a user within an electronic messaging system 102. In one or more embodiments, the act 1410 also includes displaying a notification 906 to the user that the promotional message 912 is from the page owner 106. Further, delivering the promotional message 912 to the user can involve sending the promotional message 912 via push message.

The method 1400 also includes an act 1420 of monitoring the user's interactions for a period. In particular, the act 1420 involves monitoring the user's interactions with the electronic messaging system 102 for a period. In one or more embodiments, the act 1420 involves determining that the user engages with the promotional message 912 by detecting an impression of the promotional message 912 by the user.

The period can correspond to a number of intervals. For example, in one or more embodiments, the period aligns with an offer expiration date presented in the promotional message 912. In some embodiments, the period is a time length such as a day, a period of days, a week, a month, or a period of months. In other embodiments, the period is defined by a number of message threads being delivered to the user after delivery of the promotional message 912 or by the user logging into the instant messenger system a minimum number of times after delivery of the promotional message 912.

In addition, the method 1400 includes an act 1430 of determining that the user did not engage with the message. In particular, the act 1430 involves determining, based on the monitored interactions that the user did not engage with the promotional message 912 during the period. In some embodiments, the act 1430 involves determining that the user's interactions with the electronic messaging system 102 for the period indicate that the user ignored or did not open the promotional message 912 during the period.

The method 1400 also includes an act 1440 of revoking 1214 the message from the user. In particular, the act 1440 involves revoking 1214, upon determining that the user did not engage with the promotional message 912 during the period, the promotional message 912 from the user. In one or more embodiments, the act 1440 involves sending a delete command 1212 to revoke the promotional message 912 from the user. In some embodiments, revoking a promotional message 912 involves removing the promotional message 912 from the user's communication thread with the merchant.

The method 1400 can also include one or more additional acts. For example, the method 1400 includes the act of delivering 1220 an additional promotional message 912 to the user after revoking the promotional message 912. In some cases, the additional promotional message 912 is different from the promotional message 912. In addition, the method 1400 can include the acts of receiving an updated promotional message 912 from the merchant and delivering the updated promotional message 912 to the user in connection with revoking the promotional message 912.

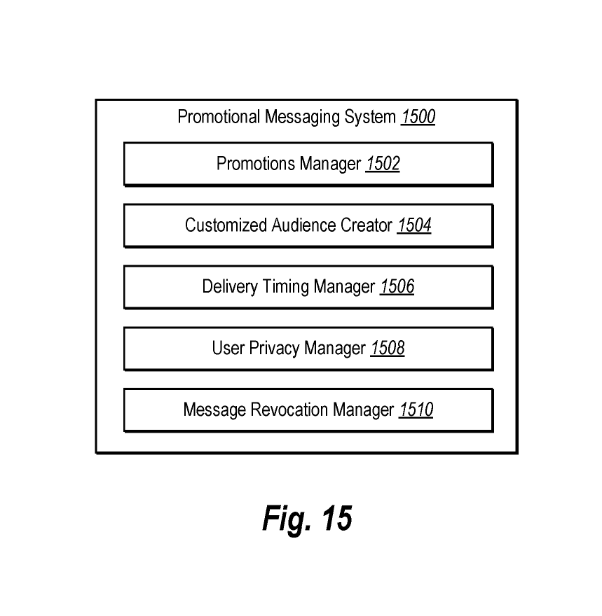

FIG. 15 illustrates a schematic diagram of a promotional messaging system 1500. The promotional messaging system 1500 can be an example embodiment of the promotional messaging system described above. Further, the promotional messaging system 104 can be executed on an electronic messaging system and/or social networking system, such as the electronic messaging system and social networking system described with respect to FIG. 1.

As shown in FIG. 15, the promotional messaging system 1500 can include various components for performing the processes and features described herein. For example, in the embodiment shown in FIG. 15, the promotional messaging system 1500 includes a promotions manager 1502, a customized audience creator 1504, a delivery timing manager 1506, a user privacy manager 1508, and a message revocation manager 1510.

The components 1502-1510 of the promotional messaging system 1500 can comprise software, hardware, or both. For example, the components 1502-1510 can comprise one or more instructions stored on a computer-readable storage medium and executable by processors of one or more computing devices, such as a client device or server device. When executed by the one or more processors, the computer-executable instructions of the promotional messaging system 1500 can cause the computing device(s) to perform the feature learning methods described herein. Alternatively, the components 1502-1510 can comprise hardware, such as a special purpose processing device to perform a certain function or group of functions. Alternatively, the components 1502-1510 of the promotional messaging system 1500 can comprise a combination of computer-executable instructions and hardware.

As mentioned above, the promotional messaging system 1500 includes a promotions manager 1502. In general, the promotions manager 1502 assist in creating, modifying, and executing promotional campaign via an electronic messaging system, as described above. For example, the promotions manager 1502 guides a merchant using a merchant system through the process of creating promotional messages to be sent to users of the electronic messaging system. In addition, the promotions manager 1502 provides merchant insights to a merchant, as previously explained.

The customized audience creator 1504 facilitates the creation of customized audiences. For example, for one or more promotional campaigns associated with a merchant, the customized audience creator 1504 creates customized audience that includes users of the electronic messaging system who have previously communicated with the merchant via the electronic messaging system, as described above. Further, the customized audience creator 1504 enables a merchant to tailor a customized audience to a particular target audience, as previously discussed.

The delivery timing manager 1506 determines an optimal time to deliver promotional messages to users of the electronic messaging system. For example, the delivery timing manager 1506 analyzes a user's activity patterns with the electronic messaging system to determine an optimal time to deliver a promotional message, such that the users sees the promotional message, but is not interrupted by the delivery of the promotional message. Further, as described above, the delivery timing manager 1506 can identify predicted behaviors in determining a delivery time to deliver a promotional message to a user.

The user privacy manager 1508 protects the privacy of users who receive promotional messages. In particular, the user privacy manager 1508 hides the identity and other private information about a user from a merchant when delivering a promotional message to the user on behalf of the merchant. The user privacy manager 1508 provides the user, as described above, with the option to share his or her information with the merchant. Further, upon the user agreeing to share his or her identity with the merchant, the user privacy manager 1508 reveals the promotional message to the merchant, as previously described.

The message revocation manager 1510 revokes stale messages that a user has missed or ignored. In particular, the message revocation manager 1510 monitors a user's activity with respect to a delivered promotional message, as previously described. Based on the user's activity, if the user has not read the promotional message for a period, the message revocation manager 1510 revokes promotional messages. In some embodiments, the message revocation manager 1510 determines a new promotional message to send to the user after revoking the previous promotional message.

FIG. 16 illustrates a block diagram of exemplary computing device 1600 that may be configured to perform one or more of the processes described above. One will appreciate that the computing device 1600 may represent one or more client devices or server devices or, such as those described previously. Further, the computing device 1600 may represent various types of computing devices. For example, the computing device 1600 can include: a mobile device such as a mobile telephone, a smartphone, a PDA, a tablet, a laptop; a non-mobile device such as a desktop or server; or any other type of computing device.

As shown by FIG. 16, the computing device 1600 can comprise a processor 1602, a memory 1604, a storage device 1606, an I/O interface 1608, and a communication interface 1610, which may be communicatively coupled by way of a communication infrastructure 1612. While an exemplary computing device 1600 is shown in FIG. 16, the components illustrated in FIG. 16 are not intended to be limiting. Additional or alternative components may be used in other embodiments. Furthermore, in certain embodiments, the computing device 1600 can include fewer components than those shown in FIG. 16.

In one or more embodiments, the processor 1602 includes hardware for executing instructions, such as those making up a computer program. The memory 1604 may be used for storing data, metadata, and programs for execution by the processor(s). The storage device 1606 includes storage for storing data or instructions.

The I/O interface 1608 allows a user to provide input to, receive output from, and otherwise transfer data to and receive data from computing device 1600. The I/O interface 1608 may include a mouse, a keypad or a keyboard, a touchscreen, a camera, an optical scanner, network interface, modem, other known I/O devices or a combination of such I/O interfaces. The I/O interface 1608 may also include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1608 is configured to provide graphical data to a display for presentation to a user. The graphical data may be representative of one or more graphical user interfaces and/or any other graphical content as may serve a particular implementation.

The communication interface 1610 can include hardware, software, or both. In any event, the communication interface 1610 can provide one or more interfaces for communication (such as, for example, packet-based communication) between the computing device 1600 and one or more other computing devices or networks. As an example, the communication interface 1610 may include a network interface controller (NIC) or network adapter for communicating with an Ethernet or other wire-based network or a wireless NIC (WNIC) or wireless adapter for communicating with a wireless network, such as a WI-FI. The communication infrastructure 1612 may include hardware, software, or both that couples components of the computing device 1600 to each other. As an example, the communication infrastructure 1612 may include one or more types of buses.

As mentioned above, embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor receives instructions, from a non-transitory computer-readable medium, (e.g., memory, etc.), and executes those instructions, thereby performing one or more processes, including one or more of the processes described herein.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Computer-executable instructions comprise, for example, instructions and data which, when executed by a processor, cause a general-purpose computer, a special-purpose computer, or a special-purpose processing device to perform a certain function or group of functions. In some embodiments, a general-purpose computer executes computer-executable instructions, which turns the general-purpose computer into a special-purpose computer implementing elements of the disclosure.

Those skilled in the art will appreciate that the disclosure may be practiced in network computing environments with many types of computer system configurations. The disclosure may also be practiced in distributed system environments where local and remote computer systems, which are linked through a network, both perform tasks. Embodiments of the present disclosure can also be implemented in cloud computing environments. In this description, “cloud computing” is defined as a model for enabling on-demand network access to a shared pool of configurable computing resources.

As mentioned above, the promotional messaging system can be included in a social networking system. A social networking system may enable its users (such as persons or organizations) to interact with the system and with each other. The social networking system may, with input from a user, create and store in the social networking system a user profile associated with the user. As described above, the user profile may include demographic information, communication channel information, and information on personal interests of the user.

In more detail, user profile information may include, for example, biographic information, demographic information, behavioral information, the social information, or other types of descriptive information, such as work experience, educational history, hobbies or preferences, interests, affinities, or location. Interest information may include interests related to one or more categories, which may be general or specific. As an example, if a user “likes” an article about a brand of shoes, the category may be the brand.

The social networking system may also, with input from a user, create and store a record of relationships of the user with other users of the social networking system, as well as provide services (e.g. wall posts, photo-sharing, online calendars and event organization, messaging, games, or advertisements) to facilitate social interaction between or among users. Also, the social networking system may allow users to post photographs and other multimedia content items to a user's profile page (typically known as “wall posts” or “timeline posts”) or in a photo album, both of which may be accessible to other users of the social networking system depending on the user's configured privacy settings. Herein, the term “friend” may refer to any other user of the social networking system with which a user has formed a connection, association, or relationship via the social networking system.

FIG. 17 illustrates an example network environment 1700 of a social networking system. Network environment 1700 includes a client device 1706, a social networking system 1702, and a third-party system 1708 connected to each other by a network 1704. Although FIG. 17 illustrates a particular arrangement of client device 1706, the social networking system 1702, the third-party system 1708, and the network 1704, this disclosure contemplates any suitable arrangement and number of client device 1706, the social networking system 1702, the third-party system 1708, and the network 1704.

Links may connect the client device 1706, the social networking system 1702, and the third-party system 1708 to the network 1704 or to each other. Links need not necessarily be the same throughout network environment 1700. One or more first links may differ in one or more respects from one or more second links.

In some embodiments, client device 1706 may be an electronic device including hardware, software, or embedded logic components or a combination of two or more such components and capable of carrying out the appropriate functionalities implemented or supported by the client device 1706. As an example, a client device 1706 may include any of the computing devices discussed above in relation to FIG. 16. The client device 1706 may enable a network user at the client device 1706 to access the network 1704. The client device 1706 may enable its user to communicate with other users at other client devices or systems.

In some embodiments, the client device 1706 may include a web browser, such as and may have one or more add-ons, plug-ins, or other extensions. The client device 1706 may render a webpage based on the HTML files from the server for presentation to the user.

In some embodiments, the social networking system 1702 may be a network-addressable computing system that can host an online social network. The social networking system 1702 may generate, store, receive, and send social-networking data, such as, for example, user-profile data, concept-profile data, the social-graph information, or other suitable data related to the online social network. The social networking system 1702 may be accessed by the other components of the network environment 1700 either directly or via the network 1704.

In some embodiments, the social networking system 1702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, etc., or any combination thereof.

In some embodiments, the social networking system 1702 may include one or more data stores. Data stores may be used to store various types of information. In some embodiments, the information stored in data stores may be organized according to specific data structures. Particular embodiments may provide interfaces that enable the client device 1706, the social networking system 1702, or the third-party system 1708 to manage, retrieve, modify, add, or delete, the information stored in data stores.

In some embodiments, the social networking system 1702 may store one or more social graph, described below. In one or more embodiments, the social networking system 1702 may provide users with the ability to take actions on various types of items or objects, supported by social networking system 1702. As an example, the items and objects may include groups or social networks to which users of the social networking system 1702 may belong, events or calendar entries in which a user might be interested, computer-based applications that a user may use, transactions that allow users to buy or sell items via the customer service, interactions with advertisements that a user may perform, etc. A user may also interact with anything that is capable of being represented in the social networking system 1702 or by an external system of the third-party system 1708, which is separate from the social networking system 1702 and coupled to the social networking system 1702 via the network 1704.

The social networking system 1702 can include a variety of stores, modules, and/or managers as described below. In one or more embodiments, a connection manager may be used for storing connection information about users. The connection information may indicate users who have similar or common work experience, group memberships, hobbies, educational history, or are in any way related or share common attributes. The connection information may also include user-defined connections between different users and content (both internal and external). An action logging manager may be used to receive communications from a web server about a user's actions on or off the social networking system 1702. In conjunction with the action log, a third-party content object log may be maintained of user exposures to third-party content objects. An advertisement-pricing module may combine social information, the current time, location information, or other suitable information to provide relevant advertisements, in the form of notifications, to a user.

Authorization servers may be used to enforce one or more privacy settings of the users of the social networking system 1702. A privacy setting of a user determines how particular information associated with a user can be shared. The authorization server may allow users to opt in to or opt out of having their actions logged by the social networking system 1702 or shared with other systems (e.g., the third-party system 1708), such as, for example, by setting appropriate privacy settings.

In some embodiments, the third-party system 1708 may include one or more types of servers, one or more data stores, one or more interfaces, including but not limited to APIs, one or more web services, one or more content sources, one or more networks, or any other suitable components. The third-party system 1708 may be operated by a different entity from an entity operating the social networking system 1702 even if, in some embodiments, the social networking system 1702 and the third-party systems 1708 operate in conjunction with each other. In this sense, the social networking system 1702 may provide a platform, or backbone, which other systems, such as the third-party systems 1708, may use to provide social-networking services and functionality to users across the Internet.

In some embodiments, a third-party system 1708 may include a third-party content object provider. A third-party content object provider may include one or more sources of content objects, which may be communicated to the client device 1706. As an example, content objects may include information regarding things or activities of interest to the user. As another example, content objects may include incentive content objects.

FIG. 18 illustrates an example social graph 1800. In some embodiments, the social networking system 1702 may store one or more social graphs 1800 in one or more data stores. In some embodiments, the social graph 1800 may include multiple nodes—which may include multiple user nodes 1802 or multiple concept nodes 1804—and multiple edges 1806 connecting the nodes. The social graph 1800 illustrated in FIG. 18 is shown, for didactic purposes, in a two-dimensional visual map representation.

In some embodiments, a user node 1802 may correspond to a user of social networking system 1702. When a user registers for an account with social networking system 1702, the social networking system 1702 may create a user node 1802 corresponding to the user, and store the user node 1802 in one or more data stores. Users and user nodes 1802 described herein may, where appropriate, refer to registered users and user nodes 1802 associated with registered users.

In some embodiments, a concept node 1804 may correspond to a concept. As an example, a concept may correspond to a place, a website, an entity, a resource, etc. A concept may be located within social networking system 1702 or on an external server. A concept node 1804 may be associated with information of a concept provided by a user or information gathered by various systems, including the social networking system 1702.

In some embodiments, a node in social graph 1800 may represent or be represented by an online profile page. Profile pages may be hosted by or accessible to social networking system 1702. Profile pages may be viewable by all or a selected subset of other users. As an example, a user node 1802 may have a corresponding user-profile page where the corresponding user may add content, make declarations, or otherwise express him or herself. As another example, a concept node 1804 may have a corresponding concept-profile page in which one or more users may add content, make declarations, or express themselves, particularly in relation to the concept corresponding to concept node 1804.

As an example, an edge 1806 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships.

In some embodiments, a pair of nodes in social graph 1800 may be connected to each other by one or more edges 1806. An edge 1806 connecting a pair of nodes may represent a relationship between the pair of nodes. In some embodiments, an edge 1806 may include or represent one or more data objects or attributes corresponding to the relationship between a pair of nodes. As an example, a first user may indicate that a second user is a “friend” of the first user. In response to this indication, the social networking system 1702 may send a “friend request” to the second user. If the second user confirms the “friend request,” the social networking system 1702 may create an edge 1806 connecting the first user's user node 1802 to the second user's user node 1802 in social graph 1800 and store edge 1806 as social-graph information in one or more of data stores.

In some embodiments, an edge 1806 between a user node 1802 and a concept node 1804 may represent a particular action or activity performed by a user associated with user node 1802 toward a concept associated with a concept node 1804. As an example, as illustrated in FIG. 18, a user may “liked,” “attended,” “played,” “listened,” “cooked,” “worked at,” or “watched” a concept, each of which may correspond to an edge type or subtype.

In some embodiments, the social networking system 1702, the client device 1706, or the third-party system 1708 may access the social graph 1800 and related social-graph information for suitable applications. The nodes and edges of social graph 1800 may be stored as data objects, for example, in a data store (such as a social-graph database). Such a data store may include one or more searchable or queryable indexes of nodes or edges of social graph 1800.

In some embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition, or as an alternative, an advertisement may be one or more sponsored stories (e.g., a news feed or ticker item on the social networking system 1702).

An advertisement may also include social networking system functionality with which a user may interact. As an example, an advertisement may enable a user to “like” or otherwise endorse the advertisement by selecting an icon or link associated with an endorsement. In addition or as an alternative, an advertisement may include social networking system context directed to the user. As an example, an advertisement may display information about a friend of the user within social networking system 1702 who has taken an action associated with the subject matter of the advertisement.

In some embodiments, the social networking system 1702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof Affinity may also be determined with respect to objects associated with third-party systems 1708 or other suitable systems. An overall affinity for a social-graph entity for each user, subject matter, or type of content may be established. The overall affinity may change based on continued monitoring of the actions or relationships associated with the social-graph entity.

In some embodiments, the social networking system 1702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions.

Coefficients may be used to predict any number of actions, which may be within or outside of the online social network. As an example, these actions may include various types of communications, such as sending messages, posting content, or commenting on content; various types of observation actions, such as accessing or viewing profile pages, media, or other suitable content; various types of coincidence information about two or more social-graph entities, such as purchasing a product from a merchant.

In some embodiments, the social networking system 1702 may use a variety of factors to calculate a coefficient. These factors may include, for example, user actions, types of relationships between objects, location information, other suitable factors, or any combination thereof. In some embodiments, different factors may be weighted differently when calculating the coefficient. The weights for each factor may be static, or the weights may change according to, for example, the user, the type of relationship, the type of action, the user's location, and so forth. Ratings for the factors may be combined according to their weights to determine an overall coefficient for the user.

To calculate the coefficient of a user towards a particular object, the rating assigned to the user's actions may comprise, for example, 60% of the overall coefficient, while the relationship between the user and the object may comprise 40% of the overall coefficient. In some embodiments, the social networking system 1702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof.

A coefficient may include a decay factor that causes the strength of the signal provided by particular actions to decay with time, such that actions that are more recent are more relevant when calculating the coefficient. The ratings and weights may be continuously updated based on continued tracking of the actions upon which the coefficient is based. Any process or algorithm may be employed for assigning, combining, averaging, and so forth the ratings for each factor and the weights assigned to the factors. In some embodiments, the social networking system 1702 may determine coefficients using machine-learning algorithms trained on historical actions and past user responses, or data farmed from users by exposing them to various options and measuring responses.

In some embodiments, the social networking system 1702 may calculate a coefficient based on a user's actions. The social networking system 1702 may monitor such actions on the online social network, on the third-party system 1708, on other suitable systems, or any combination thereof. Typical user actions include viewing profile pages, creating or posting content, interacting with content, joining groups, listing and confirming attendance at events, checking-in at locations, liking particular pages, creating pages, and performing other tasks that facilitate social action.

In some embodiments, the social networking system 1702 may calculate a coefficient based on the user's actions with particular types of content. The content may be associated with the online social network, the third-party system 1708, or another suitable system. The social networking system 1702 may analyze a user's actions to determine whether one or more of the actions indicate an affinity for subject matter, content, other users, and so forth.

In some embodiments, the social networking system 1702 may calculate a coefficient based on the type of relationship between particular objects. Referencing the social graph 1800, the social networking system 1702 may analyze the number and/or type of edges 1806 connecting particular user nodes 1802 and concept nodes 1804 when calculating a coefficient. As an example, depending upon the weights assigned to the actions and relationships for the particular user, the overall affinity may be determined to be higher for content about a user's spouse than for content about a user's friend.

In some embodiments, the coefficient may be based on the degree of separation between particular objects. The degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 1800.

In some embodiments, the social networking system 1702 may calculate a coefficient based on location information. Objects that are geographically closer to each other may be considered to be more related, or of more interest, to each other than more distant objects. In some embodiments, the coefficient of a user towards a particular object may be based on the proximity of the object's location to a current location associated with the user (or the location of a client device 1706 of the user). A first user may be more interested in other users or concepts that are closer to the first user. As an example, if a user is one mile from an airport and two miles from a gas station, the social networking system 1702 may determine that the user has a higher coefficient for the airport than the gas station based on the proximity of the airport to the user.

In some embodiments, the social networking system 1702 may perform particular actions with respect to a user based on the coefficient information. The coefficients may be used to predict whether a user will perform a particular action based on the user's interest in the action. A coefficient may be used when generating or presenting any type of objects to a user. The coefficient may also be utilized to rank and order such objects, as appropriate. In this way, the social networking system 1702 may provide information that is relevant to user's interests and current circumstances, increasing the likelihood that they will find such information of interest.

In some embodiments, the social networking system 1702 may generate search results based on the coefficient information. Search results for a particular user may be scored or ranked based on the coefficient associated with the search results with respect to the querying user. As an example, search results corresponding to objects with higher coefficients may be ranked higher on a search-results page than results corresponding to objects having lower coefficients.

In connection with social-graph affinity and affinity coefficients, particular embodiments may utilize one or more systems, components, elements, functions, methods, operations, or steps disclosed in U.S. patent application Ser. No. 11/503093, filed Aug. 11, 2006, U.S. patent application Ser. No. 12/977027, filed Dec. 22, 2010, U.S. patent application Ser. No. 12/978265, filed Dec. 23, 2010, and U.S. patent application Ser. No. 13/632869, filed Oct. 1, 2012, each of which is incorporated by reference in their entirety.

In some embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. In some embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network.

In some embodiments, one or more servers may be authorization/privacy servers for enforcing privacy settings. In response to a request from a user (or other entity) for a particular object stored in a data store, the social networking system 1702 may send a request to the data store for the object. The request may identify the user associated with the request and may only be sent to the user (or the client device 1706 of the user) if the authorization server determines that the user is authorized to access the object based on the privacy settings associated with the object.

The preceding specification is described with reference to specific exemplary embodiments thereof. The description above and drawings are illustrative and are not to be construed as limiting. The additional or alternative embodiments may be embodied in other specific forms without departing from its spirit or essential characteristics. The scope of the invention is, therefore, indicated by the appended claims rather than by the preceding description. All changes that come within the meaning and range of equivalency of the claims are to be embraced within their scope.

What is claimed is:

1. A method comprising:
delivering a promotional message on behalf of a page owner to a user within an electronic messaging system;
monitoring the user's interactions with the electronic messaging system for a period;
determining, based on the monitored interactions and by at least one processor, that the user did not engage with the promotional message during the period; and
revoking, upon determining that the user did not engage with the promotional message during the period, the promotional message from the user.

2. The method of claim 1, further comprising delivering the promotional message to the user via a push notification.

3. The method of claim 1, further comprising sending a delete command to revoke the promotional message from the user.

4. The method of claim 1, further comprising determining that the user engages with the promotional message by detecting an impression of the promotional message by the user.

5. The method of claim 1, further comprising determining the user's interactions with the electronic messaging system for the period indicate that the user ignored or did not open the promotional message during the period.

6. The method of claim 1, further comprising delivering an additional promotional message to the user after revoking the promotional message.

7. The method of claim 6, wherein the additional promotional message is different from the promotional message.

8. The method of claim 1, further comprising:
receiving an updated promotional message from the page owner; and
delivering the additional promotional message to the user in connection with revoking the promotional message.

9. The method of claim 1, wherein the period aligns with an offer expiration date presented in the promotional message.

10. The method of claim 1, wherein the period comprises a day, a period of days, a week, a month, or a period of months.

11. The method of claim 1, wherein the period is defined by a number of message threads being delivered to the user after delivery of the promotional message.

12. The method of claim 1, wherein the period is defined by the user logging into the instant messenger system a minimum a minimum number of times after delivery of the promotional message.

13. A system comprising:
at least one processor; and
at least one non-transitory computer readable storage medium storing instructions that, when executed by the at least one processor, cause the system to:
deliver a promotional message on behalf of a page owner to a user within an electronic messaging system;
monitor the user's interactions with the electronic messaging system for a period;
determine, based on the monitored interactions, that the user did not engage with the promotional message during the period; and
revoke, upon determining that the user did not engage with the promotional message during the period, the promotional message from the user.

14. The system of claim 13, further comprising instructions that, when executed by the at least one processor, cause the system to deliver the promotional message to the user via a push notification.

15. The system of claim 13, further comprising instructions that, when executed by the at least one processor, cause the system to send a delete command to revoke the promotional message from the user.

16. The system of claim 13, further comprising instructions that, when executed by the at least one processor, cause the system to determine that the user engages with the promotional message by detecting an impression of the promotional message by the user.

17. The system of claim 13, further comprising instructions that, when executed by the at least one processor, cause the system to determine the user's interactions with the electronic messaging system for the period indicate that the user ignored or did not open the promotional message during the period.

18. The system of claim 13, further comprising instructions that, when executed by the at least one processor, cause the system to deliver an additional promotional message to the user after revoking the promotional message.

19. The system of claim 18, wherein the additional promotional message is different from the promotional message.

20. A non-transitory computer readable medium storing instructions that, when executed by at least one processor, cause a computer system to:
deliver a promotional message on behalf of a page owner to a user within an electronic messaging system;
monitor the user's interactions with the electronic messaging system for a period;
determine, based on the monitored interactions, that the user did not engage with the promotional message during the period; and
revoke, upon determining that the user did not engage with the promotional message during the period, the promotional message from the user.
